(19) United States
(12) Patent Application Publication
(10) Pub. No.: US 2012/0147300 A1
(43) Pub. Date: Jun. 14, 2012

(54) OPTICAL FILM, POLARIZING PLATE, SURFACE FILM FOR LIQUID CRYSTAL DISPLAY DEVICE AND IMAGE DISPLAY DEVICE

(75) Inventors: Kenichi FUKUDA, Kanagawa (JP); Yuta TAKAHASHI, Kanagawa (JP)

(73) Assignee: FUJIFILM CORPORATION, Tokyo (JP)

(21) Appl. No.: 13/307,661

(22) Filed: Nov. 30, 2011

(30) Foreign Application Priority Data
Dec. 10, 2010 (JP) 2010-276432

(51) Int. Cl. G02F 1/1335; G02B 5/30

(52) U.S. Cl. 349/96; 359/492.01; 349/194

(57) ABSTRACT

An optical film includes, in the following order: an optically anisotropic layer; a transparent support; and a hardcoat layer, in-plane retardation of the optical film at a wavelength of 550 nm is from 80 to 200 nm and retardation in a direction of thickness of the optical film at a wavelength of 550 nm is from −70 to 70 nm.

### CROSS-REFERENCE TO RELATED APPLICATIONS

This application claims the benefit of Japanese Patent Application JP 2010-276432, filed Dec. 10, 2010, the entire content of which is hereby incorporated by reference, the same as if set forth at length.

### FIELD OF THE INVENTION

The present invention relates to an optical film comprising an optically anisotropic layer on one side of a transparent support and a hardcoat layer on the other side of the transparent support, a polarizing plate having the optical film, and an image display device. More particularly, it relates to an optical film which is suitably used as a surface film for liquid crystal display device, a polarizing plate having the optical film as a protective film, and a liquid crystal display device having the optical film placed on a surface so as to be arranged the hardcoat layer on the viewing side and the optically anisotropic layer on a polarizing film.

### BACKGROUND OF THE INVENTION

The liquid crystal display device (LCD) is widely used because of its thinness, lightness and low power consumption. The liquid crystal display device includes a liquid crystal cell and a polarizing plate. The polarizing plate is ordinarily composed of a protective film and a polarizing film and is obtained by dyeing the polarizing film made of a polyvinyl alcohol film with iodine, stretching the polarizing film and laminating the protective films on both surfaces thereof. In a transmission type liquid crystal display device, ordinarily, the polarizing plates are attached to both sides of the liquid crystal cell and further one or more optical compensation films (retardation films) are provided inside (on the liquid crystal cell side) the two polarizing plates. The optical compensation films are also used as the protective films in some cases. As the optical compensation film, for example, that comprising a base film having thereon an optically anisotropic layer in which a discotic liquid crystalline compound is fixed while keeping the orientation state is widely used.

In recent years, due to high performance of the liquid crystal display device, development of stereoscopic image display device using a transmission type liquid crystal display device has been made. For example, as a system of stereoscopic image display, there is described in JP-A-2010-243705 (the term “JP-A” as used herein means an “unexamined published Japanese patent application”) a transmission type liquid crystal display device of field-sequential two eyes stereoscopic vision in which a retardation film (λ/4 plate) having a front retardation (in-plane retardation) of λ/4 having an optical axis inclined at +45° to a vertical polarizing axis of linear polarized light output from a liquid crystal cell is provided outside the polarizing plate.

As the retardation film having a front retardation of 214, that formed by using a stretched film and that having an optically anisotropic layer formed from a curable liquid crystalline compound on a transparent base film are exemplified.

Among them, since the stretched film is ordinarily prepared by being stretched in the length direction or in the width direction, the slow axis thereof is parallel or orthogonal to the length direction.

In case of sticking a retardation film and a polarizer in the production of polarizing plate, it is preferred in view of production efficiency to stick the retardation film and the polarizer in a roll-to-roll system.

On the other hand, in the liquid crystal display device, a stretched film of polyvinyl alcohol is ordinarily used as a polarizing film and an absorption axis of polarization is parallel to the length direction.

Accordingly, in order to stick the retardation film having the slow axis in 45° direction to the polarizing axis and the polarizer in the roll-to-roll system, a roll-shaped film of the retardation film having the slow axis in 45° direction is needed and thus, the stretched film is unfit for sticking in the roll-to-roll system.

On the contrary, the retardation film having an optically anisotropic layer formed from a curable liquid crystalline compound is suitable for sticking in the roll-to-roll system because the direction of slow axis can freely be changed by controlling an orientation direction of the liquid crystalline compound according to a method, for example, rubbing.

In JP-A-2007-155970, it is described that a λ/4 plate in the form of roll film having the slow axis in 45° direction in which a polymerizable rod-like liquid crystalline compound is orientated on a triacetyl cellulose film as a base film is prepared and the λ/4 plate is stuck to a polarizer in the roll-to-roll system to prepare an elliptical polarizing plate. The elliptical polarizing plate thus-prepared has a configuration of optically anisotropic layer/orientated film/base film/polarizer/protective film and a liquid crystal cell is arranged on the side of the optically anisotropic layer and the protective layer is arranged on a viewing side of a display device.

Although there is no description in JP-A-2007-155970, it is considered that as the protective film arranged on the surface side of the display device, a hardcoat film is ordinarily used for the purpose of imparting function of scratch resistance.

In case of using the elliptical polarizing plate having the configuration described in JP-A-2007-155970 as the λ/4 plate in the transmission type liquid crystal display device of field-sequential two eyes stereoscopic vision described in JP-A-2010-243705, it is considered that since the optically anisotropic layer is arranged on the viewing side of display device, a hardcoat film is preferably used at the outermost surface in order to impart the scratch resistance. When the hardcoat film (ordinarily comprising a transparent support having thereon a hardcoat layer) is attempted to be provide on the surface of optically anisotropic layer, a configuration of hardcoat layer/transparent support/adhesive layer/optically anisotropic layer/orientated film/base film/polarizer/protective film is formed to cause a problem in that the surface member (polarizing plate) becomes thick.

### SUMMARY OF THE INVENTION

In summary, it is needed to develop an optical film which imparts retardation and surface scratch resistance and also provides a polarizing plate satisfying requirement of the decrease in thickness.

As a result of the initiation of development of a surface film suitable for the transmission type liquid crystal display device of field-sequential two eyes stereoscopic vision using an optically anisotropic layer based on existing knowledge, the inventors has been found two novel problems which are heretofore not known.

The first problem is that a transmission type liquid crystal display device of field-sequential two eyes stereoscopic vision in which a λ/4 layer formed from a polymerizable rod-like liquid crystalline compound provided on a triacetyl cellulose film described in JP-A-2007-155970 as a base film is loaded is excellent in display performance when viewed from front, but when it is viewed from an oblique direction, crosstalk is observed to degrade the image quality. The inventors have found that this problem can be dissolved by controlling Re and Rth of an optical film so as to bring an Nz factor (Rth/Re+0.5) close to 0.5. A configuration of the optical film (optically anisotropic layer/orientated film/transparent support/hardcoat layer) according to the invention can bring the Nz factor close to 0.5. However, it has been found that in case of the configuration of forming only a hardcoat film on a λ/4 plate (configuration of base film/orientated film/optically anisotropic layer/adhesive layer/transparent support/hardcoat layer) as in Sample No. 139 for comparative example described hereinafter, the Nz factor is larger than 1 and the problem of crosstalk can not be dissolved when viewed from an oblique direction.

The second problem is that interference unevenness caused by the refractive index difference between a transparent base film and an optically anisotropic layer occurs and the display quality of a liquid crystal display device having such an optical film loaded is deteriorated. It has been found that, in particular, in the configuration of hardcoat layer/transparent support/adhesive layer/optically anisotropic layer/orientated film/base film/polarizer/protective film, the occurrence of interference unevenness due to reflected light generated at the interfaces between the optically anisotropic layer and the base film or the adhesive layer adjacent thereto is severe.

The present invention relates to a composite film having a function of a surface protective film and a function of a retardation film and provides an optical film which has high productivity, has high surface hardness, is free from interference unevenness, exhibits excellent image quality of an image display device having the optical film loaded therein, and is suitable for the decrease in thickness of a polarizing plate. It also relates to a polarizing plate and liquid crystal display device having the optical film loaded therein.

As a result of the intensive investigations, the inventors have found that these problems can be dissolved by commonalizing base materials of a hardcoat layer and an optically anisotropic layer to form an optical film comprising an optically anisotropic layer on one side of a transparent support and a hardcoat layer on the other side of the transparent support and controlling in-plane retardation and retardation in the direction of thickness of the optical film to complete the invention.

In particular, the optical film having a support composed of cellulose acylate and an optically anisotropic layer formed from a composition containing a discotic liquid crystalline compound is especially also excellent in the image quality in the oblique direction.

The above-described objects of the invention can be achieved by the following constitution.

(1) An optical film comprising: an optically anisotropic layer; a transparent support; and a hardcoat layer, wherein in-plane retardation of the optical film at a wavelength of 550 nm is from 80 to 200 nm and retardation in a direction of thickness of the optical film at a wavelength of 550 nm is from −70 to 70 nm.
(2) The optical film as described in (1) above, wherein an oriented film is provided between the transparent support and the optically anisotropic layer.
(3) The optical film as described in (1) or (2) above, wherein retardation in a direction of thickness of the transparent support at a wavelength of 550 nm is from 20 to 100 nm.
(4) The optical film as described in any one of (1) to (3) above, wherein the optically anisotropic layer is an optically anisotropic layer formed form a composition containing a liquid crystalline compound.
(5) The optical film as described in (4) above, wherein the liquid crystalline compound is a discotic liquid crystalline compound.
(6) The optical film as described in any one of (1) to (5) above, wherein a surface irregularity shape of a surface of the optical film on a side at which the hardcoat layer is provided is from 0 to 0.08 μm in terms of an arithmetic average roughness (Ra) according to JIS B 0601.
(7) The optical film as described in any one of (1) to (6) above, wherein a surface haze of the optical film is 1% or less.
(8) The optical film as described in any one of (1) to (7) above, wherein an internal haze of the optical film is from 1 to 10%.
(9) The optical film as described in any one of (1) to (8) above, wherein a transmittance of the transparent support at a wavelength of 380 nm is 10% or less.
(10) The optical film as described in any one of (1) to (9) above, wherein the hardcoat layer contains a binder and a light-transmitting particle, an average particle size of the light-transmitting particle is from 1 to 12 μm, and an absolute value of a refractive index difference between the binder and the light-transmitting particle is from 0.01 to less than 0.05.
(11) The optical film as described in any one of (1) to (10) above, wherein a low refractive index layer having a refractive index lower than that of the transparent support is provided on a side of the hardcoat layer opposite to a side provided with the transparent support.
(12) The optical film as described in any one of (1) to (11) above, which is in a long-length roll form, and a slow axis of front retardation is present at 5 to 85° in a clockwise or counterclockwise direction with reference to a longitudinal direction.
(13) The optical film as described in any one of (1) to (12) above, which is a surface film for a liquid crystal display device.
(14) A polarizing plate comprising at least one protective film and a polarizing film, wherein at least one of the protective films is the optical film as described in any one of (1) to (13) above, and a surface of the optically anisotropic layer side of the optical film and the polarizing film are stuck.
(15) An image display device comprising the optical film as described in any one of (1) to (13) above and the polarizing plate as described in (14) above.
(16) A liquid crystal display device comprising the optical film as described in any one of (1) to (13) above, a polarizing film and a liquid crystal cell in this order from a viewing side, wherein the optical film is provided so that the hardcoat layer is arranged on the viewing side and the optically anisotropic layer is arranged on the polarizing film side.

According to the present invention, an optical film which has high productivity, has high surface hardness, is free from interference unevenness, exhibits excellent image quality (e.g., excellent in optical compensation, free from crosstalk or the like) of an image display device having the optical film loaded therein, and is suitable for the decrease in thickness of a polarizing plate and an image display device having the optical film loaded therein can be provided.

Also, the optical film according to the invention is suitable for a stereoscopic image display device based on a transmission type liquid crystal display device.

### DETAILED DESCRIPTION OF THE INVENTION

Exemplary embodiments of the present invention will be described in detail below, but the invention should not be construed as being limited thereto. In the case where a numerical value represents a physical value, a characteristic value or the like, the expression “from (numerical value 1) to (numerical value 2)” as used herein means “from (numerical value 1) or more to (numerical value 2) or less”.

The optical film according to the invention is an optical film comprising an optically anisotropic layer on one side of a transparent support and a hardcoat layer on the other side of the transparent support, wherein in-plane retardation (Re (550)) of the optical film at a wavelength of 550 nm is from 80 to 200 nm and retardation in a direction of thickness (Rth (550)) of the optical film at a wavelength of 550 nm is from −70 to 70 nm.

Materials used in the optical film, polarizing plate and image display device according to the invention and production methods thereof will be described in detail below.

### [Transparent Support]

### [Material of Transparent Support]

As a material for forming the transparent support according to the invention, a polymer excellent in optical performance transparency, mechanical strength, thermal stability, moisture blocking property, isotropy or the like is preferred. The term “transparency” as used herein means that a transmittance of visible light is 60% or more. The transmittance is preferably 80% or more, and particularly preferably 90% or more. For instance, a polycarbonate film, a polyester polymer, for example, polyethylene terephthalate or polyethylene naphthalate, an acrylic polymer, for example, polymethyl methacrylate, and a styrene polymer, for example, polystyrene or an acrylonitrile-styrene copolymer (AS resin) are exemplified. Also, polyolefin, for example, polyethylene or polypropylene, a polyolefin polymer, for example, an ethylene-propylene copolymer, a vinyl chloride polymer, an amide polymer, for example, nylon or an aromatic polyamide, an imide polymer, a sulfone polymer, a polyethersulfone polymer, a polyetheretherketone polymer, a polyphenylene sulfide polymer, a vinylidene chloride polymer, a vinyl alcohol polymer, a vinyl butyral polymer, an arylate polymer, a polyoxymethylene polymer, an epoxy polymer, and a mixture of the polymers described above are exemplified. Further, the polymer film according to the invention may also be formed as a cured layer of an ultraviolet curing or thermal curing resin of an acrylic type, urethane type, acrylurethane type, epoxy type, silicone type or the like.

Moreover, as the material for forming the transparent support according to the invention, a thermoplastic norbornene resin can be preferably used. As the thermoplastic norbornene resin, ZEONEX and ZEONOR produced by Zeon Corp. and ARTON produced by JSR Corp. are exemplified.

Furthermore, as the material for forming the transparent support according to the invention, a cellulose polymer (particularly preferably, cellulose acylate) which has been conventionally used as a transparent protective film of a polarizing plate and is typified by triacetyl cellulose is preferably used. As an example of the transparent support according to the invention, the cellulose acylate is mainly described in detail below, but it is apparent that the technical matter can also be applied to other polymer films.

### [Substitution Degree of Cellulose Acylate]

The cellulose acylate is a cellulose in which a hydroxy group is acylated, and the substituent may be any acyl group from an acyl group having 2 carbon atoms to an acetyl group having 22 carbon atoms. In the cellulose acylate according to the invention, the substitution degree to the hydroxy group of cellulose is not particularly limited. The substitution degree can be determined by calculation after measuring the bonding degree of an acetic acid and/or a fatty acid having from 3 to 22 carbon atoms substituted to the hydroxy group of cellulose. As for the measuring method, the measurement can be performed according to ASTM D-817-91.

In the cellulose acylate, the substitution degree to the hydroxy group of cellulose is not particularly limited and is preferably from 2.50 to 3.00, more preferably from 2.75 to 3.00, and still more preferably from 2.85 to 3.00.

Of the acetic acid and/or fatty acid having from 3 to 22 carbon atoms substituted to the hydroxy group of cellulose, the acyl group having from 2 to 22 carbon atoms is not particularly limited and may be an aliphatic group or an aromatic group or may be a single acyl group or a mixture of two or more kinds of acyl groups. Examples of the cellulose ester acylated with such an acid include an alkylcarbonyl ester of cellulose, an alkenylcarbonyl ester of cellulose, an aromatic carbonyl ester of cellulose and an aromatic alkylcarbonyl ester of cellulose, and these esters each may further have a substituted group. Preferred examples of the acyl group include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a tert-butanoyl group, a cyclohexanecarbonyl group, an oleoyl group, a benzoyl group, a naphthylcarbonyl group and a cinnamoyl group. Among them, an acetyl group, a propionyl group, a butanoyl group, a dodecanoyl group, an octadecanoyl group, a tert-butanoyl group, an oleoyl group, a benzoyl group, a naphthylcarbonyl group and a cinnamoyl group are more preferred, and an acetyl group, a propionyl group and a butanoyl group are more preferred.

### [Polymerization Degree of Cellulose Acylate]

The polymerization degree of the cellulose acylate preferably used in the invention is preferably from 180 to 700 in terms of a viscosity average polymerization degree and in case of cellulose acetate, it is more preferably from 180 to 550, still more preferably from 180 to 400, and particularly preferably from 180 to 350, in terms of the viscosity average polymerization degree.

### [Additives for Transparent Support]

Various additives (for example, an optical anisotropy adjusting agent, a wavelength dispersion adjusting agent, a fine particle, a plasticizer, an ultraviolet preventing agent, a deterioration preventing agent or a releasing agent) may be added to the transparent support according to the invention and they are described below. In the case where the transparent support is a cellulose acylate film, the timing of the addition thereof may be at any time during a dope preparation step (preparation step of cellulose acylate solution) and the addition may also be conducted by introducing a step of adding the additive to prepare a dope at the final stage of the dope preparation step.

### [Ultraviolet Absorbing Agent]

The transparent support of the optical film according to the invention preferably contains an ultraviolet absorbing agent (UV absorbing agent). By the incorporation of ultraviolet absorbing agent, an ultraviolet absorbing property can be provided to the transparent support. By the incorporation of ultraviolet absorbing agent into the transparent support, yellow coloring (for example, observed as decrease in the transmittance at a wavelength of 400 nm) of the support or retardation change (for example, observed as Re change) of the optically anisotropic layer laminated on one side of the support, which is caused by exposure to an ultraviolet ray included in outside light, can be prevented. Specific examples of the UV absorbing agent include compounds described in Paragraph Nos. [0059] to [0135] of JP-A-2006-199855.

The transmittance of the transparent support at a wavelength of 380 nm is preferably 50% or less, more preferably 20% or less, still more preferably 10% or less, and most preferably 5% or less.

### [Matting Agent Fine Particle]

In the transparent support according to the invention, a fine particle is preferably added as a matting agent. Examples of the fine particle include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. A fine particle containing silicon is preferred in view of providing low turbidity and silicon dioxide is particularly preferred. The fine particle of silicon dioxide is preferably a fine particle having an average primary particle diameter of 20 nm or less and an apparent specific gravity of 70 g/liter or more. A fine particle having an average primary particle diameter as small as 5 to 16 nm is more preferred, because the haze of the film can be reduced. The apparent specific gravity is preferably from 90 to 200 g/liter or more, more preferably from 100 to 200 g/liter or more. As the apparent specific gravity is larger, a dispersion liquid having a higher concentration can be prepared and this is preferred in view of improvements in haze and aggregate.

The fine particle ordinarily forms a secondary particle having an average particle diameter from 0.1 to 3.0 μm and is present in the film as an aggregate of primary particles to form a salient of 0.1 to 3.0 μm on the film surface. The average secondary particle diameter is preferably from 0.2 to 1.5 μm, more preferably from 0.4 to 1.2 μm, and most preferably from 0.6 to 1.1 μm. As for the primary and secondary particle diameters, particles in the film are observed by a scanning electron microscope and a diameter of a circle circumscribing the particle is defined as the particle diameter. Also, 200 particles are observed in different places and the average value thereof is defined as the average particle diameter. Further, the state of irregularity on the film surface can be measured by means of, for example, AFM.

As the fine particles of silicon dioxide, a commercially available product, for example, AEROSIL R972, AEROSIL R972V, AEROSIL R974, AEROSIL R812, AEROSIL 200, AEROSIL 200V, AEROSIL 300, AEROSIL R202, AEROSIL OX50 and AEROSIL TT600 (produced by Nihon Aerosil Co., Ltd.) may be used. The fine particle of zirconium oxide is also commercially available under the trade name, for example, of AEROSIL R976 or AEROSIL R811 (produced by Nihon Aerosil Co., Ltd.), and these may be used.

Among them, AEROSIL 200V and AEROSIL R972V are particularly preferred, because they are fine particles of silicon dioxide having an average primary particle diameter of 20 nm or less and an apparent specific gravity of 70 g/liter or more and provide a large effect of decreasing a friction coefficient while maintaining low turbidity of the optical film.

### [Compound Decreasing Optical Anisotropy]

Specific examples of the compound which decreases the optical anisotropy of the transparent support include, for example, compounds described in Paragraph Nos. [0035] to [0058] of JP-A-2006-199855, but the invention should not be construed as being limited thereto.

### [Plasticizer, Degradation Preventing Agent, Releasing Agent]

In addition to the compound which decreases the optical anisotropy, UV absorbing agent and matting agent, various additives (for example, a plasticizer, a deterioration preventing agent, a releasing agent or an infrared absorbing agent) may be added depending on the intended use to the transparent support according to the invention as described above. The additive may be a solid material or an oily material. Details of the materials are described on pages 16 to 22 of JIII Journal of Technical Disclosure (Kogi No. 2001-1745, published on Mar. 15, 2001, Japan Institute of Invention and Innovation).

### [Knurling]

The transparent support according to the invention preferably has a knurling portion at a film edge thereof in order to inhibit generation of black band or deformation of the film due to handling thereof in a roll form even when the transparent support has a large width and a small thickness. The knurling portion means a portion which is formed by imparting irregularity at the edge in the width direction of the transparent long-length support to make balky and is preferably provided on both edges. As for a method for imparting irregularity to form the knurling portion, the knurling portion can be formed by pressing a heated emboss roll to the film. Since fine irregularity is formed on the emboss roll, the irregularity can be formed on the film by pressing the emboss roll against the film to form a bulky portion at the edge. The height of the knurling portion according the invention means height from the film surface to top of the salient formed by the embossing. The knurling portion may be provided on both surfaces of the transparent support, or 3 or more knurling portions may be formed on one surface. The height of the knurling portion is preferably a height larger than the entire thickness of the optical functional layers including the optically anisotropic layer and the hard coat layer, by 1 μm or more, and the width of one knurling portion is preferably in a range from 5 to 30 mm. In the case of providing the knurling portions on both surfaces of the film, the sum of the height of each knurling portion is larger by 1 μm or more. By adjusting the height larger by 1 μm or more, the effect of inhibiting generation of black band and deformation of the film is obtained. The height of the knurling portion is preferably larger than the entire thickness of the optically functional film by 2 to 10 μm. By controlling the height in this range, generation of black band and deformation of the film can be prevented, and troubles, for example, deformation of the support due to winding slippage or bulge of the knurling portion do not occur.

### [Optically Anisotropic Layer]

The optically anisotropic layer in the optical film according to the invention will be described. The optically anisotropic layer means a layer which can generate anisotropy when formed on the transparent support as described above.

In the optically anisotropic layer according to the invention, materials and production conditions can be selected according to various uses, and a λ/4 film using a polymerizable liquid crystalline compound is one preferred embodiment.

First, a method of measuring an optical characteristic is described below. In the specification, Re (λ) and Rth (λ) indicate an in-plane retardation and an retardation in the thickness direction at a wavelength λ, respectively. The Re (λ) is measured by means of KOBRA 21ADH or KOBRA WR (produced by Oji Scientific Instruments) while applying light having a wavelength of λ nm in the normal line direction of the film. For the selection of the measuring wavelength λ, a wavelength-selecting filter is manually exchanged or the measured value is converted by a program or the like. In the case where the film to be measured is a film expressed by a uniaxial or biaxial refractive index ellipsoid, the Rth (λ) is calculated in the following manner. The measuring method is partly utilized in the measurement of the average tilt angle on the orientated film side of discotic liquid crystal molecule in the optically anisotropic layer as described hereinafter and the average tilt angle on the opposite side thereof.

The Rth (λ) is calculated by KOBRA 21ADH or KOBRA WR based on 6 retardation values, an assumed value of average refractive index and an inputted thickness value. The 6 retardation values are obtained by measuring the Re (λ) at a total of 6 points by applying light having a wavelength of λ nm to a film from 6 directions from the normal line direction of the film to a direction tilted at 50° from the normal line direction with 10° interval using an in-plane slow axis (determined by KOBURA 21ADH or KOBURA WR) as a tilt axis (rotation axis) (in the case where the film does not have the slow axis, any desired in-plane direction of the film may be used as the rotation axis). In the above calculation, when the film has a retardation value of zero at a certain tilt angle to the normal line using the in-plane slow axis as the rotation axis, positive sign of a retardation value at a tilt angle larger than the certain tilt angle is converted to negative sign and then the calculation is conducted by KOBRA 21ADH or KOBRA WR. Further, using the slow axis as the tilt axis (rotation axis) (in the case where the film does not have the slow axis, any desired in-plane direction of the film may be used as the rotation axis), a retardation value is determined in any desired two tilt directions and, based on the data obtained, the assumed value of average refractive index and the inputted film thickness value(d), Rth of the film can also be calculated according to formulae (A) and (III) shown below.

$$Re ( θ ) = [ nx - \frac{( ny \times nz )}{( \sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}} )} ] \times \frac{d}{cos ( {sin}^{- 1} ( \frac{sin ( - θ )}{nx} ) )} \qquad Formula ( A )$$

In the formulae (A) and (III), Re (θ) represents a retardation value in the direction tilted at an angle θ from the normal line direction, nx represents a refractive index in the in-plane slow axis direction, ny represents a refractive index in the direction perpendicular to the slow axis direction in the plane, and nz represents a refractive index in the direction perpendicular to the above directions.

Rth=((nx+ny)/2−nz)×d Formula (III)

In the case where the film to be measure cannot be expressed as a uniaxial or biaxial refractive index ellipsoid, specifically, in the case where the film to be measure has no so-called optic axis, Rth (λ) is calculated in the following manner. The Rth (λ) is calculated by KOBRA 21ADH or KOBRA WR based on 11 retardation values, an assumed value of average refractive index and an inputted thickness value. The 11 retardation values are obtained by measuring the Re (λ) at a total of 11 points by applying light having a wavelength of λ nm to a film from 11 directions tilted at −50° to +50° with 10° interval to the normal line direction of the film using an in-plane slow axis (determined by KOBURA 21ADH or KOBURA WR) as a tilt axis (rotation axis). In the above measurement, as the assumed value of average refractive index, values described in Polymer Handbook (JOHN WILEY & SONS, INC.) and catalogs of various optical films can be used. In the case where a value of average refractive index is unknown, the value can be measured by an Abbe refractometer. The average refractive indexes of major optical films are shown below: cellulose acylate (1.48), cycloolefin polymer (1.52), polycarbonate (1.59), polymethyl methacrylate (1.49), and polystyrene (1.59). By inputting the assumed value of the average refraction index and thickness value, nx, ny and nz are calculated by KOBRA 21ADH or KOBRA WR. Further, Nz=(nx−nz)/(nx−ny) is calculated from the calculated nx, ny and nz.

### [Retardation of Optically Anisotropic Layer]

The front retardation Re (550) at a wavelength of 550 nm of the optically anisotropic layer according to the invention is preferably from 80 to 200 nm, more preferably from 90 to 180 nm, and still more preferably from 100 to 170 nm.

The front retardation Re (550) at a wavelength of 550 nm of the optical film according to the invention is preferably from 80 to 200 nm, more preferably from 100 to 170 nm, and still more preferably from 110 to 160 nm.

By controlling the front retardation Re (550) at a wavelength of 550 nm in the range described above, for example, front crosstalk or decrease in brightness can be inhibited when the optical film is loaded in the transmission type liquid crystal display device of field-sequential two eyes stereoscopic vision. In particular, the effects are remarkably obtained when a viewer views the display device with cocking his head.

The retardation in the direction of thickness Rth (550) at a wavelength of 550 nm of the optical film is from −70 to 70 nm, preferably from −60 to 60 nm, more preferably from −50 to 50 nm, and particularly preferably from −20 to 20 nm.

By controlling the Rth (550) in the range described above, crosstalk in an oblique direction or decrease in brightness can be inhibited when the optical film is loaded in the transmission type liquid crystal display device of field-sequential two eyes stereoscopic vision.

The Nz (=Rth (550)/Re (550)+0.5) calculated from the Re (550) and Rth (550) at the wavelength of 550 nm is preferably from −0.50 to 1.50, more preferably from −0.10 to 1.10, still more preferably from 0.1 to 0.9, and particularly preferably from 0.3 to 0.7.

### [Optically Anisotropic Layer Containing Liquid Crystalline Compound]

The optically anisotropic layer according to the invention is preferably formed using a liquid crystalline compound. The kind of the liquid crystalline compound used is not particularly restricted. For example, an optically anisotropic layer obtained by forming a low molecular liquid crystalline compound in the nematic alignment in a liquid crystal state and then fixing by photocrosslinking or thermal crosslinking or an optically anisotropic layer obtained by forming a high molecular liquid crystalline compound in the nematic alignment in a liquid crystal state and then cooling to fix the alignment can be used. Further, in the invention, even when a liquid crystalline compound is used in the optically anisotropic layer, the optically anisotropic layer is a layer formed by fixing the liquid crystalline compound by polymerization or the like and thus does not need to show crystallinity once the layer is formed. A polymerizable liquid crystalline compound may be a multifunctional polymerizable liquid crystalline compound or a monofunctional polymerizable liquid crystalline compound.

Moreover, the liquid crystalline compound may be a discotic liquid crystalline compound (also referred to as a disc-shaped liquid crystalline compound) or a rod-shaped liquid crystalline compound. In order to obtain favorable optical characteristic (particularly, the retardation in the direction of thickness Rth (550) at a wavelength of 550 nm), the discotic liquid crystalline compound is more preferred.

In the optically anisotropic layer, a molecule of the liquid crystalline compound is preferably fixed in any alignment state of vertical alignment, horizontal alignment, hybrid alignment and inclined alignment. In order to prepare a retardation plate having symmetrical viewing angle dependence, it is preferred that a disc plane of the discotic liquid crystalline compound is substantially vertical to the film plane (optically anisotropic layer plane) or that a long axis of the rod-shaped liquid crystalline compound is substantially horizontal to the film plane (optically anisotropic layer plane). The term “discotic liquid crystalline compound is substantially vertical” as used herein means that an average value of angles between the film plane (optically anisotropic layer plane) and the disc plane of the discotic liquid crystalline compound is within a range from 70 to 90°. The average value of angles is more preferably from 80 to 90°, and still more preferably from 85 to 90°. The term “rod-shaped liquid crystalline compound is substantially horizontal” as used herein means that an average value of angles between the film plane (optically anisotropic layer plane) and the director of the rod-shaped liquid crystalline compound is within a range from 0 to 20°. The average value of angles is more preferably from 0 to 10°, and still more preferably from 0 to 5°.

In the case of preparing an optical compensation film having asymmetric viewing angle dependence by orienting a molecule of the liquid crystalline compound in a hybrid alignment, an average tilt angle of the director of the liquid crystalline compound is preferably from 5 to 85°, more preferably from 10 to 80°, and still more preferably from 15 to 75°.

The optically anisotropic layer in the optical film according to the invention may be composed of a single layer or may be a laminate of two or more optically anisotropic layers.

The optically anisotropic layer can be formed by coating on a support a coating solution containing a liquid crystalline compound, for example, a rod-shaped liquid crystalline compound or a discotic liquid crystalline compound and, if desired, a polymerization initiator, an alignment controlling agent and other additives described hereinafter. It is preferred to form the optically anisotropic layer by forming an oriented film on the support and then coating the above-described coating solution on the surface of the oriented film.

### [Discotic Liquid Crystalline Compound]

In the invention, it is preferred to use a discotic liquid crystalline compound in the formation of the optically anisotropic layer of the optical film. The discotic liquid crystalline compound is described in various documents (C. Destrade, et al., Mol. Crysr. Liq. Cryst., Vol. 71, page 111 (1981), The Chemical Society of Japan, Kikan Kagaku Sousetu (Quarterly Journal of Chemistry Review), No. 22, Ekisho no Kagaku (Chemistry of Liquid Crystal), Chap. 5, Chap. 10, Sec. 2 (1994), B. Kohne, et al., Angew. Chem. Soc. Chem. Comm., page 1794 (1985), and J. Zhang, et al., J. Am. Chem. Soc., Vol. 116, page 2655 (1994)). Polymerization of the discotic liquid crystalline compound is described in JP-A-8-27284.

Specific examples of the discotic liquid crystalline compound which can be preferably used in the invention include compounds described in Paragraph Nos. [0038] to [0069] of JP-A-2009-97002. Also, a triphenylene compound which is a discotic liquid crystalline compound having a small wavelength dispersion includes, for example, compounds described in Paragraph Nos. [0062] to [0067] of JP-A-2007-108732.

In the case of forming the optically anisotropic layer using a discotic liquid crystalline compound, an average value of angles between the film plane (optically anisotropic layer plane) and the disc plane of the discotic liquid crystalline compound is preferably in a range from 70 to 90°, more preferably from 80 to 90°, and still more preferably from 85 to 90°, as described above.

The optimum retardation required for the transparent support may be varied depending on a material for forming the optically anisotropic layer. In the case where the optically anisotropic layer contains a discotic liquid crystalline compound and the discotic liquid crystalline compound is aligned at the angle described above, the retardation in the direction of thickness Rth (550) at a wavelength of 550 nm of the transparent support is preferably from 20 to 100 nm, more preferably from 30 to 90 nm, and particularly preferably from 40 to 80 nm. By controlling the Rth (550) of the transparent support in the range described above, the Rth (550) of the optical film can be controlled in the preferred range described above.

The in-plane retardation Re (550) at a wavelength of 550 nm of the transparent support is preferably from 0 to 10 nm, more preferably from 0 to 8 nm, and particularly preferably from 0 to 6 nm.

In the case of using a cellulose acylate film as the transparent support, the preferred retardation in the direction of thickness and in-plane retardation described above can be easily obtained. An embodiment using a cellulose acylate film as the transparent support and a discotic liquid crystalline compound in the optically anisotropic layer is particularly preferred in view of achieving the optical characteristic for the optical film described above.

### [Rod-Shaped Liquid Crystalline Compound]

In the invention, a rod-shaped liquid crystalline compound may be used in the optically anisotropic layer. As the rod-shaped liquid crystalline compound, an azomethine, an azoxy, a cyano biphenyl, a cyano phenyl ester, a benzoic acid ester, a cyclohexanecarboxylic acid phenyl ester, a cyanophenylcyclohexane, acyano-substituted phenylpyrimidine, an alkoxy-substituted phenylpyrimidine, a phenyldioxane, a tolane and an alkenylcyclohexylbenzonitrile are preferably used. Not only the low molecular liquid crystalline compound as described above, but also a high molecular liquid crystalline compound can be used. It is more preferred to fix the alignment by polymerization of the rod-shaped liquid crystalline compound. A liquid crystalline compound having a partial structure capable of undergoing polymerization or a crosslinking reaction with active light, an electron beam, heat or the like can be preferably used. The number of such partial structures is preferably from 1 to 6, and more preferably from 1 to 3. As a polymerizable rod-shaped liquid crystalline compound, compounds described, for example, in Makromol. Chem., Vol. 190, page 2255 (1989), Advanced Materials, Vol. 5, page 107 (1993), U.S. Pat. Nos. 4,683,327, 5,622,648 and 5,770,107, WO95/22586, WO95/24455, WO97/00600, WO98/23580, WO98/52905, JP-A-1-272551, J-A-6-16616, JP-A-7-110469, JP-A-11-80081 and JP-A-2001-328973 can be used.

The optimum retardation required for the transparent support may be varied depending on a material for forming the optically anisotropic layer as described above. In the case where the optically anisotropic layer contains a rod-shaped liquid crystalline compound and the rod-shaped liquid crystalline compound is aligned at the angle described above, the retardation in the direction of thickness Rth (550) at a wavelength of 550 nm of the transparent support is preferably from −120 to 20 nm, more preferably from −100 to 10 nm, and particularly preferably from −80 to −50 nm. By controlling the Rth (550) of the transparent support in the range described above, the Rth (550) of the optical film can be controlled in the preferred range described above.

The in-plane retardation Re (550) at a wavelength of 550 nm of the transparent support is preferably from 0 to 10 nm, more preferably from 0 to 8 nm, and particularly preferably from 0 to 6 nm.

### [Vertical Alignment Accelerating Agent]

In order to uniformly align molecules of the liquid crystalline compound vertically in the formation of the optically anisotropic layer, it is preferred to use an alignment controlling agent capable of vertically controlling alignment of the liquid crystalline compound both on an oriented film interface side and on an air interface side. For this purpose, it is preferred to form the optically anisotropic layer by using a composition containing a compound which exerts the action of vertically aligning the liquid crystalline compound on the oriented film upon an exclusion volume effect, an electrostatic effect or a surface energy effect together with the liquid crystalline compound. With respect to the control of the alignment on the air interface side, it is preferred to form the optically anisotropic layer by using a composition containing a compound which is localized on the air interface side at the time of alignment of the liquid crystalline compound and exerts the action of vertically aligning the liquid crystalline compound upon an exclusion volume effect, an electrostatic effect or a surface energy effect together with the liquid crystalline compound. As the compound (oriented film interface side vertical alignment agent) which accelerates vertical alignment of the molecules of the liquid crystalline compound on the oriented film interface side, a pyridinium derivative can be preferably used. As the compound (air interface side vertical alignment agent) which accelerates vertical alignment of the molecules of the liquid crystalline compound on the air interface side, a compound containing a fluoroaliphatic group which accelerates the localization of the compound on the air interface side and one or more hydrophilic groups selected from a carboxyl group (—COOH), a sulfo group (—SO₃H), a phosphonoxy group {—OP(═O)(OH)₂} and the salts thereof is preferably used. Further, for example, in the case of preparing a coating solution of the crystalline compound, by adding the compound a coating property of the coating solution is improved to inhibit the generation of unevenness and repelling. The vertical alignment agent will be described in detail below.

### [Oriented Film Interface Side Vertical Alignment Agent]

As the oriented film interface side vertical aligning agent for use in the invention, a pyridinium derivative (pyridinium salt) can be preferably used. Specific examples of the compound include compounds described in Paragraph Nos. [0058] to [0061] of JP-A-2006-113500.

The content of the pyridinium derivative in the composition for forming the optically anisotropic layer may be varied depending on its use and is preferably from 0.005 to 8% by weight, more preferably from 0.01 to 5% by weight, in the composition (a liquid crystalline composition excluding a solvent in the case of preparing the composition as a coating solution).

### [Air Interface Side Vertically Aligning Agent]

As the air interface side vertically aligning agent, a fluorine-based polymer (containing a repeating unit represented by formula (II) as a partial structure) or a fluorine-containing compounds represented by formula (III) is preferably used.

First, the fluorine-based polymer (containing a repeating unit represented by formula (II) as a partial structure) will be described. As for the air interface side vertically aligning agent, the fluorine-based polymer is preferably a copolymer containing a repeating unit derived from a fluoroaliphatic group-containing monomer and a repeating unit represented by formula (II) shown below.

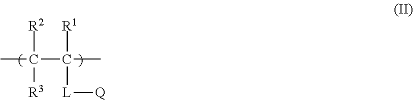

In formula (II), R¹, R², and R³ each independently represents a hydrogen atom or a substituent, L represents a divalent connecting group selected from Group of connecting groups shown below or a divalent connecting group formed by combining two or more groups selected from Group of connecting groups shown below,

### (Group of Connecting Groups):

a single bond, —O—, —CO—, —NR⁴— (wherein R⁴ represents a hydrogen atom, an alkyl group, an aryl group or an aralkyl group), —S—, —SO₂—, —P(═O)(OR⁵)— (wherein R⁵ represents an alkyl group, an aryl group or an aralkyl group), an alkylene group and an arylene group, and Q represents a carboxyl group (—COOH) or its salt, a sulfo group (—SO₃H) or its salt or a phosphonoxy group {—OP(═O)(OH)₂} or its salt.

The fluorine-based polymer which can be used in the invention is characterized in that it contains a fluoroaliphatic group and one or more hydrophilic groups selected from the group consisting of a carboxyl group (—COOH), a sulfo group (—SO₃H), a phosphonoxy group {—OP(═O)(OH)₂} and salts thereof. As to the kind of the polymer, descriptions are made on pages 1 to 4 in Kaitei Kobunshi Gousei no Kagaku (Revised Chemistry of Polymer Synthesis) written by Takayuki Otsu, published by Kagaku-dojin Publishing Company, Inc (1968). Examples thereof include a polyolefin, a polyester, a polyamide, a polyimide, a polyurethane, a polycarbonate, a polysulfone, a polyether, a polyacetal, a polyketone, a polyphenylene oxide, a polyphenylene sulfide, a polyarylate, a PTFE, a polyvinylidene fluoride and a cellulose derivative. The fluorine-based polymer is preferably a polyolefin.

The fluorine-based polymer is a polymer having the fluoroaliphatic group in its side chain. The fluoroaliphatic group contains preferably from 1 to 12 carbon atoms, and more preferably from 6 to 10 carbon atoms. The aliphatic group may be a chain structure or a cyclic structure, and the chain structure may be straight-chain or branched. Among them, a straight-chain fluoroaliphatic group having from 6 to 10 carbon atoms is preferred. The substitution degree of the fluoroaliphatic group with fluorine atoms is not particularly limited and is preferably such that 50% or more of the hydrogen atoms in the aliphatic group are substituted with fluorine atoms, and more preferably such that 60% or more of the hydrogen atoms in the aliphatic group are substituted with fluorine atoms. The fluoroaliphatic group is included in side chain connected to the main chain through, for example, an ester bond, an amido bond, an imido bond, a urethane bond, a urea bond, an ether bond, a thioether bond or an aromatic ring.

Specific examples of the fluoroaliphatic group-containing copolymer preferably used in the invention as the fluorine-based polymer include compounds described in Paragraph Nos. [0110] to [0114] of JP-A-2006-113500, but the invention should not be construed as being limited thereto.

The weight average molecular weight of the fluorine-based polymer for use in the invention is preferably 1,000,000 or less, more preferably 500,000 or less, and still more preferably from 10,000 to 100,000. In the range described above, alignment control of the liquid crystalline compound is effectively achieved while maintaining sufficient solubility. The weight average molecular weight can be determined as a value in terms of polystyrene (PS) using gel permeation chromatography (GPC).

A preferred range of the content of the fluorine-based polymer in the composition may vary depending on its use, and in the case of using for forming the optically anisotropic layer, the content (composition excluding a solvent in the case of preparing the composition as a coating solution) is preferably from 0.005 to 8% by weight, more preferably from 0.01 to 5% by weight, and still more preferably from 0.05 to 3% by weight. When the content of the fluorine-based polymer is less than 0.005% by weight, the effect is insufficient whereas, when the content exceeds 8% by weight, drying of the coated film becomes insufficient and detrimental influences are exerted on performance as the optical film (for example, uniformity of retardation).

The fluorine-containing compound represented by formula (III) shown below will be described.

(R⁰)ₘ-L⁰-(W)ₙ Formula (III)

In formula (III), R⁰ represents an alkyl group, an alkyl group having a CF₃ group at the terminal or an alkyl group having a CF₂H group at the terminal, and m represents an integer of 1 or more. When m is 2 or more, two or more R⁰ may be the same or different from each other, provided that at least one represents an alkyl group having a CF₃ group or a CF₂H group at the terminal. L⁰ represents an (m+n) valent connecting group, W represents a carboxyl group (—COOH) or its salt, a sulfo group (—SO₃H) or its salt or a phosphonoxy group {—OP(═O)(OH)₂} or its salt, and n represents an integer of 1 or more.

Specific examples of the fluorine-containing compound represented by formula (III) which can be used in the invention include compounds described in Paragraph Nos. [0136] to of JP-A-2006-113500, but the invention should not be construed as being limited thereto.

A preferred range of the content of the fluorine-containing compound in the composition may vary depending on its use, and in the case of using for forming the optically anisotropic layer, the content (composition excluding a solvent in the case of preparing the composition as a coating solution) is preferably from 0.005 to 8% by weight, more preferably from 0.01 to 5% by weight, and still more preferably from 0.05 to 3% by weight.

### [Polymerization Initiator]

The aligned (preferably vertically aligned) liquid crystalline compound is fixed while maintaining the alignment state. Fixation is preferably conducted by a polymerization reaction of a polymerizable group (P) introduced into the liquid crystalline compound. The polymerization reaction includes a thermal polymerization reaction using a thermal polymerization initiator and a photopolymerization reaction using a photopolymerization initiator. The photopolymerization reaction is preferred. Examples of the photopolymerization initiator include an α-carbonyl compound (described in U.S. Pat. Nos. 2,367,661 and 2,367,670), an acyloin ether (described in U.S. Pat. No. 2,448,828), an α-hydrocarbon-substituted aromatic acyloin compound (described in U.S. Pat. No. 2,722,512), a polynuclear quinone compound (described in U.S. Pat. Nos. 3,046,127 and 2,951,758), a combination of triarylimidazole dimer and p-aminophenyl ketone (described in U.S. Pat. No. 3,549,367), an acridine or phenazine compound (described in JP-A-60-105667 and U.S. Pat. No. 4,239,850) and an oxadiazole compound (described in U.S. Pat. No. 4,212,970).

The amount of the photopolymerization initiator used is preferably from 0.01 to 20% by weight, more preferably from 0.5 to 5% by weight, based on the solid content of the coating solution. Light irradiation for the polymerization of liquid crystalline molecule is preferably conducted using an ultraviolet ray. The irradiation energy is preferably from 20 mJ/cm² to 50 J/cm², and more preferably from 100 to 800 mJ/cm². In order to accelerate the photopolymerization reaction, the light irradiation may be conducted under heating condition or at a low oxygen concentration of 0.1% or less. The thickness of the optically anisotropic layer containing the liquid crystalline compound is preferably from 0.1 to 10 μm, more preferably from 0.5 to 5 μm, and most preferably from 1 to 5 μm.

### [Other Additives to Optically Anisotropic Layer]

A plasticizer, a surfactant, a polymerizable monomer or the like may be used together with the liquid crystalline compound described above to improve uniformity of the coated film, film strength, alignment property of the liquid crystalline compound or the like. The materials preferably have compatibility with the liquid crystalline compound so as not to inhibit alignment.

The polymerizable monomer includes a radical polymerizable or cation polymerizable compound. A polyfunctional radical polymerizable monomer is preferred, and the monomer which is copolymerizable with the polymerizable group-containing liquid crystalline compound described above is preferred. For example, those described in Paragraph Nos. [0018] to [0020] of JP-A-2002-296423 are exemplified. The amount of the polymerizable monomer added is ordinarily in a range from 1 to 50% by weight, preferably in a range from 5 to 30% by weight, based on the weight of the liquid crystalline compound.

The surfactant includes conventionally known compounds and is preferably a fluorine-based compound. Specifically, for example, compounds described in Paragraph Nos. to [0056] of JP-A-2001-330725 and Paragraph Nos. [0069] to [0126] of Japanese Patent Application No. 2003-295212 are exemplified.

The polymer used together with the liquid crystalline compound preferably can thicken the coating solution. Examples of the polymer include a cellulose ester. Preferred examples of the cellulose ester include those described in Paragraph No. [0178] of JP-A-2000-155216. The amount of the polymer added is preferably in a range from 0.1 to 10% by weight, more preferably in a range from 0.1 to 8% by weight, based on the weight of the liquid crystalline compound so as not to inhibit alignment of the liquid crystalline compound.

The discotic nematic liquid crystal phase-solid phase transition temperature of the liquid crystalline compound is preferably from 70 to 300° C., and more preferably from 70 to 170° C.

The surface of the optically anisotropic layer containing the liquid crystalline compound according to the invention is preferably smooth in order to align the liquid crystalline compound without defects. With respect to the smoothness of the layer, arithmetic average roughness Ra in a roughness curve (JIS B 0601:1998) is preferably from 0 to 0.05 μm, and more preferably from 0.01 to 0.04 μm. On such a smooth surface, the fluorine-containing compound for aligning the liquid crystalline compound tends to transfer when contacted with the hardcoat layer side surface facing in the roll state. However, this problem can be solved in the invention by controlling the profile and the surface free energy of the hardcoat layer side surface to the specific ranges.

### [Coating Solvent]

As a solvent for use in the preparation of the coating solution, an organic solvent is preferably used. Examples of the organic solvent include an amide (for example, N,N-dimethylformamide), a sulfoxide (for example, dimethylsulfoxide), a heterocyclic compound (for example, pyridine), a hydrocarbon (for example, benzene or hexane), an alkyl halide (for example, chloroform or dichloromethane), an ester (for example, methyl acetate, ethyl acetate or butyl acetate), a ketone (for example, acetone or methyl ethyl ketone) and an ether (for example, tetrahydrofuran or 1,2-dimethoxyethane). Among them, an alkyl halide and a ketone are preferred. Two or more organic solvents may be used in combination.

### [Coating Method]

Coating of the Coating Solution can be Conducted According to a Known Method (for example, a wire bar coating method, an extrusion coating method, a direct gravure coating method, a reverse gravure coating method or a die coating method).

### [Oriented Film]

In the invention, it is preferred to coat the composition described above on the surface of an oriented film to align molecules of the liquid crystalline compound. The optical film according to the invention preferably has the oriented film between the transparent support and the optically anisotropic layer. Since the oriented film has the function of regulating alignment direction of the liquid crystalline compound, it is preferred to utilize the oriented film to realize a preferred embodiment of the invention. However, after fixing the alignment state of the liquid crystalline compound, the oriented film is not always necessary as a constituent element of the invention since the oriented film has already served its purpose. Specifically, it is possible to transfer only the optically anisotropic layer in which the alignment state has been fixed on the oriented film to a different transparent support to prepare an optical base material for the optical film according to the invention.

The oriented film can be prepared, for example, by means of a rubbing treatment of an organic compound (preferably a polymer), oblique evaporation of an inorganic compound, formation of a layer having microgroove or accumulation of organic compound (for example, ω-tricosanic acid, dioctadecylmethylammonium chloride or methyl stearate) by a Langmuir-Blodgett method (LB film). Further, an oriented film which exhibits an alignment function upon application of electric field, application of magnetic field or light irradiation is also known.

The oriented film is preferably formed by a rubbing treatment of a polymer.

Examples of the polymer include a methacrylate copolymer, a styrene copolymer, a polyolefin, polyvinyl alcohol and a modified polyvinyl alcohol, poly(N-methylolacrylamide), a polyester, a polyimide, a vinyl acetate copolymer, carboxymethyl cellulose and a polycarbonate described in Paragraph No. [0022] of JP-A-8-338913. It is possible to use a silane coupling agent as the polymer. A water-soluble polymer (for example, poly(N-methylolacrylamide), carboxymethyl cellulose, gelatin, polyvinyl alcohol or a modified polyvinyl alcohol) is preferred, gelatin, polyvinyl alcohol or a modified polyvinyl alcohol is more preferred, and polyvinyl alcohol or a modified polyvinyl alcohol is most preferred.

The saponification degree of polyvinyl alcohol is preferably from 70 to 100%, and more preferably from 80 to 100%. The polymerization degree of polyvinyl alcohol is preferably from 100 to 5,000.

In the oriented film, it is preferred to connect a side chain having a crosslinkable functional group (for example, a double bond) to a main chain or to introduce into a side chain a crosslinkable functional group having the function of aligning the liquid crystalline molecule. As the polymer used in the oriented film, either of a polymer which itself can undergo crosslinking and a polymer which can be crosslinked with a crosslinking agent can be used, and a combination of plural of them can be used.

It is possible to copolymerize the polymer in the oriented film and the polyfunctional monomer in the optically anisotropic layer, when the polymer in the oriented film has a main chain connecting to a side chain containing a crosslinkable functional group or when a crosslinkable functional group is introduced into a side chain having a function of aligning liquid crystalline molecule. In such a case, not only between the polyfunctional monomer and the polyfunctional monomer but also between the polymer in the oriented film and the polymer in the oriented film and between the polyfunctional monomer and the polymer in the oriented film, strong covalent bonds are formed. Thus, the strength of the optical compensation film can be remarkably improved by introducing a crosslinkable functional group into the polymer in the oriented film.

The crosslinkable functional group of the polymer in the oriented film preferably has a polymerizable group as in the polyfunctional monomer. Specific examples thereof include those described in Paragraph Nos. [0080] to [0100] of JP-A-2000-155216.

The polymer in the oriented film may be crosslinked using a crosslinking agent apart from the crosslinkable functional group. Examples of the crosslinking agent include an aldehyde, an N-methylol compound, a dioxane derivative, a compound to act when its carboxyl group is activated, an active vinyl compound, an active halogen compound, an isoxazole and a dialdehyde starch. Two or more crosslinking agents may be used in combination. Specific examples of the crosslinking agent include compounds described in Paragraph Nos. [0023] to [0024] of JP-A-2002-62426. An aldehyde having a high reactivity is preferred, and glutaraldehyde is particularly preferred.

The amount of the crosslinking agent added is preferably from 0.1 to 20% by weight, more preferably from 0.5 to 15% by weight, based on the weight of the polymer. The amount of the unreacted crosslinking agent remaining in the oriented film is preferably 1.0% by weight or less, and more preferably 0.5% by weight or less. When the amount is controlled within the range described above, the oriented film has sufficient durability without the occurrence of reticulation even when the oriented film is used in a liquid crystal display device for a long period of time or is left under a high temperature and high humidity atmosphere for a long period of time.

The oriented film can be fundamentally formed by coating a solution containing the polymer, the crosslinking agent and the additives described above which are the materials for forming the oriented film on the transparent support, drying with heating (to crosslink) and performing a rubbing treatment. The crosslinking reaction may be conducted at any time after coating the coating solution on the transparent support as described above. In the case of using a water-soluble polymer, for example, polyvinyl alcohol as the material for forming the oriented film, the coating solution is preferably prepared by using a mixed solvent of an organic solvent having a defoaming action (for example, methanol) and water. The weight ratio of water/methanol is preferably from 0/100 to 99/1, and more preferably from 0/100 to 91/9. By using such a mixed solvent, the generation of bubble is prevented and defects in the surface of the oriented film and further the optically anisotropic layer can be remarkably reduced.

The coating method utilized at the formation of the oriented film is preferably a spin coating method, a dip coating method, a curtain coating method, an extrusion coating method, a rod coating method or a roll coating method. The rod coating method is particularly preferred. The thickness of the oriented film after drying is preferably from 0.1 to 10 μm, more preferably from 0.2 to 5 μm, still more preferably from 0.3 to 3.0 μm, and particularly preferably from 0.4 to 2.0 μm. The drying with heating can be conducted at 20 to 110° C. In order to form sufficient crosslinkage, the drying is preferably conducted at 60 to 100 C.°, and particularly preferably at 80 to 100° C. The drying may be conducted from 1 minute to 36 hours, preferably from 1 to 30 minutes. The pH is preferably set in an optimum range for the crosslinking agent used, and in case of using glutaraldehyde, the pH is preferably from 4.5 to 5.5.

The oriented film is preferably provided on the transparent support. The oriented film can be obtained by crosslinking the polymer layer as described above and then conducting a rubbing treatment on the surface of the polymer layer.

The rubbing treatment can be conducted according to a treating method widely used in a liquid crystal alignment step of LCD. Specifically, a method of attaining alignment by rubbing the surface of the oriented film with paper, gauze, felt, rubber, nylon fiber, polyester fiber or the like in a definite direction can be used. Ordinarily, the rubbing treatment is conducted by rubbing several times with a fabric in which fibers having a uniform length and diameter are implanted averagely.

The composition described above is coated on the rubbing-treated surface of the oriented film to align the molecules of the liquid crystalline compound. Then, if desired, the polymer in the oriented film and the polyfunctional monomer contained in the optically anisotropic layer are reacted or the polymer in the oriented film is crosslinked using a crosslinking agent to form the optically anisotropic layer.

### [Hardcoat Layer]

The hardcoat layer in the optical film according to the invention is described below.

In the invention, the term “hardcoat layer” means a layer which raises pencil hardness of the transparent support when formed on the transparent support. Practically, the pencil hardness (JIS K 5400) after forming the hardcoat layer is preferably H or more, more preferably 2H or more, and most preferably 3H or more.

The thickness of the hardcoat layer is preferably from 0.4 to 35 μm, more preferably from 1 to 30 μm, and most preferably from 1.5 to 20 μm.

In the invention, the hardcoat layer may be one layer or plural layers. In the case where the hardcoat layer is composed of plural layers, the total thickness of the hardcoat layer is preferably in the range described above.

The optical film according to the invention preferably has an internal haze of 1% or more in order to make interference unevenness inconspicuous and the surface of the optical film on the side of the hardcoat layer is preferably substantially smooth in view of denseness of black.

More specifically, it is preferred to satisfy the conditions relating to the internal haze, surface haze and Ra shown below.

The internal haze of the hardcoat layer is preferably from 1 to 20%, more preferably from 1 to 15%, still more preferably from 1 to 10% in view of the interference unevenness and denseness of black. By controlling the internal haze to the range described above, the interference unevenness based on the optically anisotropic layer can make inconspicuous and the denseness of black can be set at a preferred level.

The internal haze of the optical film according to the invention is preferably from 1 to 20%, more preferably from 1 to 15%, and still more preferably from 1 to 10%.

The surface haze of the surface of the hardcoat layer laminated is preferably less than 1.0%, more preferably 0.6% or less, still more preferably 0.4% or less in view of the interference unevenness and denseness of black.

The surface haze of the optical film according to the invention is preferably less than 1.0%, more preferably 0.6% or less, and still more preferably 0.4% or less.

The surface of the hardcoat layer laminated (surface opposed to the transparent support) is substantially smooth. In the invention, arithmetic average roughness Ra in a roughness curve (JIS B 0601:1998) of the surface of the hardcoat layer laminated is preferably 0.08 μm or less, more preferably 0.07 μm or less, still more preferably 0.06 μm or less, and particularly preferably 0.05 μm or less.

### [Materials for Forming Hardcoat Layer]

In the invention, the hard coat layer can be formed by coating a composition containing a compound having an unsaturated double bond, a light-transmitting particle, a polymerization initiator and, if desired, a fluorine-containing compound or a silicone-based compound and a solvent on a support directly or via other layer, followed by drying and curing. The respective components will be described below.

### [Compound Having Unsaturated Double Bond]

The composition for forming the hard coat layer according to the invention can contain a compound having an unsaturated double bond. The compound containing an unsaturated double bond can function as a binder, and is preferably a polyfunctional monomer having two or more polymerizable unsaturated groups. The polyfunctional monomer having two or more polymerizable unsaturated groups can function as a curing agent and can enhance strength and scratch resistance of coated film. The polyfunctional monomer more preferably has 3 or more polymerizable unsaturated groups. As the monomer, a monofunctional or difunctional monomer and a trifunctional or higher functional monomer may be used in combination.

The compound having an unsaturated double bond includes compounds having a polymerizable functional group, for example, a (meth)acryloyl group, a vinyl group, a styryl group or an allyl group. Of the functional groups, a (meth)acryloyl group and —C(O)OCH═CH₂ are preferred. In particular, compounds having 3 or more (meth)acryloyl groups per molecule shown below can be preferably used.

Specific examples of the compound having a polymerizable unsaturated group include a (meth)acrylic acid diester of alkylene glycol, a (meth)acrylic acid diester of polyoxyalkylene glycol, a (meth)acrylic acid diester of polyhydric alcohol, a (meth)acrylic acid diester of ethylene oxide or propylene oxide adduct, an epoxy (meth)acrylate, a urethane (meth)acrylate and a polyester (meth)acrylate.

Among them, an ester between polyhydric alcohol and (meth)acrylic acid is preferred. Examples thereof include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)actrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate and caprolactone-modified tris(acryloxyethyl) isocyanurate.

As the polyfunctional acrylate compound having a (meth)acryloyl group, commercially available compounds may be used. For example, NK ESTER A-TMMT produced by Shin-Nakamura Chemical Co., Ltd. and KAYARAD DPHA produced by Nippon Kayaku Co., Ltd. are exemplified. The polyfunctional monomer is described in Paragraph Nos. [0114] to [0122] of JP-A-2009-98658, and it may be applied to the invention.

In view of an adhesion property to a support, a low curling property and a fixing property of a fluorine-containing compound or silicone-based compound described hereinafter, the compound having an unsaturated double bond is preferably a compound having a hydrogen bond-forming substituent. The term “hydrogen bond-forming substituent” as used herein means a substituent wherein an atom having a large electronegativity, for example, a nitrogen, oxygen, sulfur or halogen atom is connected with a hydrogen atom through a covalent bond. Specific examples thereof include OH—, SH—, —NH—, CHO— and CHN—, and a urethane (meth)acrylate and a (meth)acrylate having a hydroxy group are preferred. Commercially available polyfunctional acrylate having a (meth)acryloyl group can also be used. For example, NK OLIGO U4HA and NK ESTER A-TMM-3 produced by Shin-Nakamura Chemical Co., Ltd., and KAYARAD PET-30 produced by Nippon Kayaku Co., Ltd. are exemplified.

In order to impart a sufficient polymerization rate to provide sufficient hardness or the like, the content of the compound having an unsaturated double bond in the composition for forming the hardcoat layer according to the invention is preferably from 60 to 99% by weight, more preferably from 70 to 99% by weight, particularly preferably from 80 to 99% by weight, based on the total solid content of the composition for forming the hardcoat layer.

### [Light-Transmitting Particle]

The hardcoat layer according to the invention preferably has the internal haze of 1% or more and it is preferred to impart the internal haze by incorporating into the hardcoat layer a light-scattering fine particle having a refractive index difference from the binder for hardcoat layer.

The hardcoat layer according to the invention may be one layer or plural layers as described above, but in case of imparting the internal haze by incorporating a light-scattering fine particle into the hardcoat layer, undesirable irregularity may be generated on the surface of the hardcoat layer containing a light-scattering fine particle in some cases. Since it is preferred according to the invention that the surface of the hardcoat layer laminated is substantially smooth as described above, it is a preferred embodiment that the hardcoat layer has a two-layer constitution in which a light-scattering fine particle is incorporated only into the hardcoat layer close to the support.

Examples of the light-transmitting particle for use in the hardcoat layer include a polymethyl methacrylate particle (refractive index: 1.49), a crosslinked poly(acryl-styrene) copolymer particle (refractive index: 1.54), a melamine resin particle (refractive index: 1.57), a polycarbonate particle (refractive index: 1.57), a polystyrene particle (refractive index: 1.60), a crosslinked polystyrene particle (refractive index: 1.61), a polyvinyl chloride particle (refractive index: 1.60), a benzoguanamine-melamine-formaldehyde particle (refractive index: 1.68), a silica particle (refractive index: 1.46), an alumina particle (refractive index: 1.63), a zirconia particle, a titania particle and a particle having hollow or fine pore.

Among them, a crosslinked poly(meth)acrylate particle and crosslinked poly(acryl-styrene) particle are preferably used and, by adjusting the refractive index of the binder according to the refractive index of the light-transmitting particle selected from these particles, surface irregularity, surface haze, internal haze and total haze preferred for the hardcoat layer of the optical film according to the invention can be attained.

The refractive index of the binder (light-transmitting resin) is preferably from 1.45 to 1.70, and more preferably from 1.48 to 1.65.

Also, the difference in the refractive index between the light-transmitting particle and the binder for hardcoat layer (“refractive index of the light-transmitting particle”—“refractive index of the hardcoat layer excluding the light-transmitting particle”) is preferably less than 0.05, more preferably from 0.001 to 0.030, still more preferably from 0.001 to 0.020, in terms of the absolute value. When the difference in refractive index between the light-transmitting particle and the binder for the hardcoat layer is less than 0.05, since the refraction angle of light by the light-transmitting particle becomes smaller, the scattered light does not spread to a wide angle and preferably does not exhibit detrimental influence, for example, dissolution of polarization of the transmitted light passed through the optically anisotropic layer.

In order to realize the above-described difference in refractive index between the particle and the binder, refractive index of the light-transmitting particle may be adjusted or refractive index of the binder may be adjusted.

According to first preferred embodiment, it is preferred to use in combination a binder containing as a main component a (meth)acrylate monomer having three or more functional groups (refractive index after curing: 1.50 to 1.53) and a light-transmitting particle composed of a crosslinked poly(meth)acrylate/styrene polymer having an acryl content from 50 to 100% by weight. The difference in refractive index between the light-transmitting particle and the binder can easily be adjusted to less than 0.05 by controlling a composition ratio of the acryl component having a low refractive index to the styrene component having a high refractive index. The ratio of the acryl component to the styrene component is preferably from 50/50 to 100/0 by weight, more preferably from 60/40 to 100/0, and most preferably from 65/35 to 90/10. The light-transmitting particle composed of the crosslinked poly(meth)acrylate/styrene polymer has a refractive index preferably from 1.49 to 1.55, more preferably from 1.50 to 1.54, and most preferably from 1.51 to 1.53.

According to second preferred embodiment, an inorganic fine particle having an average particle size from 1 to 100 nm is used together with a binder containing as a main component a (meth)acrylate monomer having three or more functional groups and a refractive index of the binder composed of the monomer and the inorganic fine particle is controlled so as to adjust difference in refractive index from the existing light-transmitting particle. The inorganic particle includes particles of oxides of at least one metal selected from silicon, zirconium, titanium, aluminum, indium, zinc, tin and antimony. Specific examples thereof include SiO₂, ZrO₂, TiO₂, Al₂O₃, In₂O₃, ZnO, SnO₂, Sb₂O₃ and ITO. Preferably, SiO₂, ZrO₂ and Al₂O₃ are exemplified. The inorganic particle can be used by mixing with the monomer in the content from 1 to 90% by weight, preferably from 5 to 65% by weight, based on the total weight of the monomer.

The refractive index of the hardcoat layer excluding the light-transmitting particle can be quantitatively evaluated by directly measuring by an Abbe refractometer or by measuring a spectral reflectance spectrum or spectral ellipsometry. The refractive index of the light-transmitting particle is measured by a method wherein the light-transmitting particle is dispersed in an equal amount in solvents prepared by changing the mixing ratio of two kinds of solvents differing in the refractive index and thereby varying the refractive index, the turbidity is measured, and the refractive index of the solvent when the turbidity becomes minimum is measured by an Abbe refractometer.

The average particle size of the light-transmitting particle is preferably from 1.0 to 12 μm, more preferably from 3.0 to 12 μm, still more preferably from 4.0 to 10.0 μm, and most preferably from 4.5 to 8 μm. By adjusting the refractive index difference and the particle size of the light-transmitting particle to the above-described ranges, distribution of the scattered light angles does not spread to a wide angle and blurring of letters and reduction of contrast of a display hardly occur. The average particle size is preferably 12 μm or less in the point that increase in the thickness of the layer added is no longer required and that the problems of curling and increase in production cost are hardly caused. Further, to control the particle size in the range described above is preferred in the point that a coating amount at coating can be reduced, that drying can be conducted in a short time, and that surface state defects, for example, drying unevenness hardly occur.

As the method for measuring the average particle size of the light-transmitting particle, any measuring method which can measure an average particle size of particle can be employed. In a preferred manner, the particles are observed by a transmission-type electron microscope (magnification: 500,000 to 2,000,000×), 100 particles are measured, and an average value thereof is taken as the average particle size.

The shape of the light-transmitting particle is not particularly restricted, and in addition to a true spherical particle, the light-transmitting particle having a different shape, for example, a differently shaped particle (for example, non-true spherical particle) may also be used together. In particular, when non-true spherical particles are aligned so that the short axis thereof is uniformly directed in the normal line direction of the hardcoat layer, the particle having a smaller particle size than that of the true spherical particle can be employed.

The light-transmitting particle is incorporated in an amount preferably from 0.1 to 40% by weight, more preferably from 1 to 30% by weight, still more preferably from 1 to 20% by weight, based on the total solid content of the hardcoat layer. By adjusting the amount of the light-transmitting particle in the range described above, the internal haze can be controlled at the preferred level.

Also, the coated amount of the light-transmitting particle is preferably from 10 to 2,500 mg/m², more preferably from 30 to 2,000 mg/m², and still more preferably from 100 to 1,500 mg/m².

### <Preparation Method and Classification Method of Light-Transmitting Particle>

The preparation method of the light-transmitting particle includes a suspension polymerization method, an emulsion polymerization method, a soap-free emulsion polymerization method, a dispersion polymerization method and a seed polymerization method, and the particle may be produced by any of these methods. With respect to the production method, reference may be made, for example, to descriptions in Takayuki Otsu and Masayoshi Kinoshita, Kobunshi Gosei no Jikkenho (Experimental Method for Polymer Syntheses), page 130 and pages 146 to 147, published by Kagaku-Dojin Publishing Company, Inc., Gosei Kobunshi (Synthetic Polymer), Vol. 1, pages 246 to 290, and Vol. 3, pages 1 to 108, Japanese Patents 2,543,503, 3,508,304, 2,746,275, 3,521,560 and 3,580,320, JP-A-10-1561, JP-A-7-2908, JP-A-5-297506 and JP-A-2002-145919.

Regarding the particle size distribution of the light-transmitting particle, a monodisperse particle is preferred in view of the control of haze value and diffusibility and homogeneity of the coated surface state. The CV value which represents uniformity of the particle size is preferably 15% or less, more preferably 13% or less, and still more preferably 10% or less. Further, when a particle having a particle size larger than the average particle size by 20% or more is specified as a coarse particle, a proportion of the coarse particle is preferably 1% or less, more preferably 0.1% or less, still more preferably 0.01% or less, based on the number of total particles. As a method for obtaining the particle having such particle size distribution, it is effective to conduct classification after preparation or synthesis reaction of the particle, and the particle having the desired particle size distribution can be obtained by increasing the number of times of classification or intensifying the degree of classification.

For the classification, it is preferred to use a method, for example, an air classification method, a centrifugal classification method, a sedimentation classification method, a filtration classification method or a static classification method.

### [Photopolymerization Initiator]

Next, a photopolymerization initiator which can be incorporated into the composition for forming the hardcoat layer will be described.

Examples of the photopolymerization initiator include an acetophenone, a benzoin, a benzophenone, a phosphine oxide, a ketal, an anthraquinone, a thioxanthone, an azo compound, a peroxide, a 2,3-dialkyldione compound, a disulfide compound, a fluoroamine compound, an aromatic sulfonium, a lophine dimer, an onium salt, a borate salt, an active ester, a active halogen, an inorganic complex and a coumarin. Specific examples, preferred embodiments, commercially available products and the like of the photopolymerization initiator are described in Paragraph Nos. to [0151] of JP-A-2009-098658, and they can also be preferably used in the invention.

Various examples of the photopolymerization initiator are also described in Saishin UV Koka Gijutsu (Latest UV Curing Technology), page 159, Technical Information Institute Co., Ltd. (1991) and Kiyomi Kato, Shigaisen Koka System (Ultraviolet Ray Curing System), pages 65 to 148, Sogo Gijutsu Center Co., Ltd. (1989), and they are useful for the invention.

Preferred examples of the commercially available photoradical polymerization initiator of photo-cleavage type include Irgacure 651, Irgacure 184, Irgacure 819, Irgacure 907, Irgacure 1870 (a 7/3 mixed initiator of CGI-403/Irg 184), Irgacure 500, Irgacure 369, Irgacure 1173, Irgacure 2959, Irgacure 4265, Irgacure 4263, Irgacure 127, OXE 01 and the like produced by Ciba Specialty Chemicals Inc., KAYACURE DETX-S, KAYACURE BP-100, KAYACURE BDMK, KAYACURE CTX, KAYACURE BMS, KAYACURE 2-EAQ, KAYACURE ABQ, KAYACURE CPTX, KAYACURE EPD, KAYACURE ITX, KAYACURE QTX, KAYACURE BTC, KAYACURE MCA and the like produced by Nippon Kayaku Co., Ltd., ESACURE (KIP100F, KB1, EB3, BP, X33, KT046, KT37, KIP150, TZT) and the like produced by Sartomer Company, Inc., and a combination thereof.

The content of the photopolymerization initiator in the composition for forming the hardcoat layer according to the invention is preferably from 0.5 to 8% by weight, more preferably from 1 to 5% by weight, based on the total solid content of the composition for forming the hardcoat layer for the reason that the content is set to be sufficiently large for polymerization of a polymerizable compound contained in the composition for forming the hardcoat layer and sufficiently small for preventing excessive increase of initiation point.

### [Solvent]

The composition for forming the hardcoat layer according to the invention may contain a solvent. As the solvent, various solvents can be used in consideration of solubility of the monomer, dispersibility of the light-transmitting particle, and drying property at the coating. Examples of the organic solvent include, dibutyl ether, dimethoxyethane, diethoxyethane, propylene oxide, 1,4-dioxane, 1,3-dioxolane, 1,3,5-trioxane, tetrahydrofuran, anisole, phenetol, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIRK), 2-octanone, 2-pentanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethylcyclohexane, benzene, toluene and xylene. The solvents may be used individually or in combination of two or more thereof.

The solvent is preferably used in such an amount that the concentration of the solid content of the composition for forming the hardcoat layer according to the invention falls within a range from 20 to 80% by weight, more preferably from 30 to 75% by weight, and still more preferably from 40 to 70% by weight.

### [Layer Construction of Optical Film]

The optical film according to the invention has a hardcoat layer on one side of a transparent support and an optically anisotropic layer on the other side of the transparent support and may optionally have a single layer or plural layers having necessary functions, if desired. For example, an antireflective layer (a layer having a controlled refractive index, for example, a low refractive index layer, a medium refractive index layer or a high refractive index layer), an antistatic layer or an ultraviolet absorbing layer may be provided. The hardcoat layer may contain an antistatic agent or an ultraviolet absorbing agent.

More specific examples of the layer construction of the optical film according to the invention are shown below.

Optically anisotropic layer/oriented film/transparent support/hardcoat layer

Optically anisotropic layer/oriented film/transparent support/hardcoat layer/overcoat layer

Optically anisotropic layer/oriented film/transparent support/hardcoat layer/low refractive index layer
Optically anisotropic layer/oriented film/transparent support/hardcoat layer/high refractive index layer/low refractive index layer
Optically anisotropic layer/oriented film/transparent support/hardcoat layer/medium refractive index layer/high refractive index layer/low refractive index layer
Optically anisotropic layer/oriented film/transparent support/hardcoat layer/medium refractive index layer/high refractive index layer/low refractive index layer/antifouling layer

Of the constructions described above, it is preferred to provide a low refractive index layer at the outermost surface of the hardcoat layer side. By providing the low refractive index layer at the outermost surface, the denseness of black is more improved.

### [Material for Low Refractive Index Layer]

The materials for low refractive index layer are described below.

### [Inorganic Fine Particle]

From the standpoint of reducing the refractive index and improving the scratch resistance, an inorganic fine particle is preferably used in the low refractive index layer. The inorganic fine particle is not particularly limited as long as it has an average particle size from 5 to 120 nm, and from the standpoint of reducing the refractive index, an inorganic low refractive index particle is preferred.

The inorganic fine particle includes a magnesium fluoride fine particle and a silica fine particle because of low refractive index. Particularly, from the standpoint of refractive index, dispersion stability and cost, a silica fine particle is preferred. The size (primary particle size) of the inorganic fine particle is preferably from 5 to 120 nm, more preferably from 10 to 100 nm, still more preferably from 20 to 100 nm, and most preferably from 30 to 90 nm.

When the particle size of the inorganic fine particle is too small, the effect of improving the scratch resistance decreases whereas, when it is too large, fine irregularities are generated on the surface of low refractive index layer and the appearance, for example, denseness of black and the integrated reflectance are deteriorated. Further, in the case where a hollow silica fine particle described below is used, when the particle size is too small, the proportion of hollow portion is reduced and sufficient reduction in the refractive index cannot be achieved. The inorganic fine particle may be crystalline or amorphous, and it may be a monodisperse particle or may even be an aggregate particle as long as the predetermined particle size is satisfied. The shape is most preferably spherical, but it may be an indefinite form.

The coating amount of the inorganic fine particle is preferably from 1 to 100 mg/m², more preferably from 5 to 80 mg/m², and still more preferably from 10 to 60 mg/m². When the coating amount is too small, sufficient reduction in the refractive index can not be achieved or the effect of improving the scratch resistance decreases whereas, when it is too large, fine irregularities are generated on the surface of low refractive index layer and the appearance, for example, denseness of black and the integrated reflectance are deteriorated.

### (Porous or Hollow Fine Particle)

In order to reduce the refractive index, a fine particle having a porous or hollow structure is preferably used. A silica particle having a hollow structure is particularly preferably used. The porosity of the particle is preferably from 10 to 80%, more preferably from 20 to 60%, and most preferably from 30 to 60%. To set the porosity of the hollow fine particle in the range described above is preferred from the standpoint of reducing the refractive index and maintaining the durability of the particle.

In the case where the porous or hollow particle is silica particle, the refractive index of the fine particle is preferably from 1.10 to 1.40, more preferably from 1.15 to 1.35, and most preferably from 1.15 to 1.30. The refractive index as used herein indicates a refractive index of the particle as a whole and does not indicate a refractive index of only silica in the outer shell forming the silica particle.

Further, two or more kinds of hollow silica particles different in the average particle size can be used in combination. The average particle size of hollow silica particles can be determined from an electron micrograph.

In the invention, the specific surface area of the hollow silica is preferably from 20 to 300 m²/g, more preferably from 30 to 120 m²/g, and most preferably from 40 to 90 m²/g. The surface area can be determined by a BET method using nitrogen.

In the invention, a void-free silica particle may be used in combination with the hollow silica. The particle size of the void-free silica is preferably from 30 to 150 nm, more preferably from 35 to 100 nm, and most preferably from 40 to 80 nm

### [Method for Surface Treatment of Inorganic Fine Particle]

Further, in the invention, the inorganic fine particle can be used after surface treatment, for example, with a silane coupling agent according to a conventional method.

In particular, in order to improve the dispersibility in the binder for forming a low refractive index layer, it is preferred that the surface of the inorganic fine particle is treated with a hydrolysate of an organosilane compound and/or a partial condensate of the hydrolysate, and it is more preferred that either one or both of an acid catalyst and a metal chelate compound are used in the treatment.

The method for the surface treatment of the inorganic fine particle is described in Paragraph Nos. [0046] to [0076] of JP-A-2008-242314, and organosilane compound, siloxane compound, solvent for surface treatment, catalyst for surface treatment, metal chelate compound and the like described therein can also be preferably used in the invention.

In the low refractive index layer, a fluorine-containing or nonfluorine-containing monomer (b2) having a polymerizable unsaturated group may be used. As the nonfluorine-containing monomer, the compounds having an unsaturated double bond described as the compounds which can be used in the hardcoat layer are also preferably used. As the fluorine-containing monomer, a fluorine-containing polyfunctional monomer (d) represented by formula (I) shown below, which contains fluorine in an amount of 35% by weight or more and in which a calculated value of all inter-crosslinking molecular weight is less than 500.

Rf2{-(L)m-Y}n Formula (1)

In formula (1), Rf2 represents an n-valent group containing at least a carbon atom and a fluorine atom, n represents an integer of 3 or more, L represents a single bond or a divalent connecting group, m represents 0 or 1, and Y represents a polymerizable unsaturated group.

Rf2 may contain at least either of an oxygen atom and a hydrogen atom. Also, Rf2 is a chain structure (straight-chain or branched) or a cyclic structure.

Y is preferably a group containing two carbon atoms forming an unsaturated bond, more preferably a radical polymerizable group, particularly preferably a group selected from a (meth)acryloyl group, an allyl group, an α-fluoroacryloyl group and —C(O)OCH═CH₂. Of the groups, a (meth)acryloyl group, an allyl group, an α-fluoroacryloyl group and —C(O)OCH═CH₂, which can be radically polymerized, are more referred from the standpoint of polymerization property.

L represents a divalent connecting group, specifically an alkylene group having from 1 to 10 carbon atoms, an arylene group having from 6 to 10 carbon atoms, —O—, —S—, —N(R)—, a group of a combination of an alkylene group having from 1 to 10 carbon atoms and —O—, —S— or —N(R)—, or a group of a combination of an arylene group having from 6 to 10 carbon atoms and —O—, —S— or —N(R)—. R represents a hydrogen atom or an alkyl group having from 1 to 5 carbon atoms. In the case where L represents an alkylene group or an arylene group, the alkylene group or arylene group represented by L preferably substituted with a halogen atom, more preferably substituted with a fluorine atom.

Specific examples of the compound represented by formula (1) are described in Paragraph Nos. [0121] to [0163] of JP-A-2010-152311.

### (Method for Coating Hardcoat Layer)

The hardcoat layer for the optical film according to the invention can be formed according to the method described below.

First, a composition for forming the hardcoat layer is prepared. Then, the composition is coated on a transparent support by a dip coating method, an air-knife coating method, a curtain coating method, a roller coating method, a wire bar coating method, a gravure coating method, a die coating method or the like, and is heated to dry. A micro gravure coating method, a wire bar coating method and a die coating method (see, U.S. Pat. No. 2,681,294 and JP-A-2006-122889) are more preferred, and a die coating method is particularly preferred.

The optical film according to the invention is an optical film wherein an optically anisotropic layer containing a liquid crystalline compound is coated on one side of a transparent support, and a hard coat layer is coated on the other side thereof, and the order of coating the two layers is not particularly restricted.

After being coated on the transparent support, the hardcoat layer is conveyed as a web to a heated zone for drying a solvent. The temperature in the drying zone is preferably from 25 to 140° C. It is preferred that the temperature in the first half of the drying zone is at a comparatively low level and that in the second half of the drying zone is at a comparatively high level. However, the temperature is preferably lower than a temperature at which the components other than the solvent contained in the coating composition for each layer start to volatilize. For example, some of commercially available photoradical generators used together with an ultraviolet ray curable resin volatilize in an amount of about several 10 s % thereof within several minutes under hot air condition of 120° C., and some of monofunctional or difunctional acrylate monomers undergo volatilization under hot air condition of 100° C. In such cases, the temperature is preferably lower than a temperature at which the components other than the solvent contained in the coating composition for hardcoat layer start to volatilize as described above.

Also, in order to prevent the occurrence of drying unevenness, the drying air applied after coating the coating composition for hardcoat layer on a base film is preferably from 0.1 to 2 msec in air velocity on the coated film surface during a period wherein the solid content concentration in the coating composition is from 1 to 50%.

Further, after coating the coating composition for hardcoat layer on the base film, the difference between the temperature of the base film and the temperature of a convey roll contacting with the side of the base film opposite to the coated side is preferably controlled from 0 to 20° C., because drying unevenness due to uneven heat transmission on the convey roll is prevented.

After the drying zone for drying the solvent, the film is passed as a web through a zone where the hardcoat layer is cured by irradiation with ionizing radiation to cure the coated film. For example, in the case where the coated film is curable with an ultraviolet ray, it is preferred to cure the coated film by irradiating with an ultraviolet ray in an irradiation amount from 10 to 1,000 mJ/cm² using an ultraviolet lamp. In this occasion, the irradiation amount distribution in the width direction of the web including both edge portions is preferably from 50 to 100%, more preferably from 80 to 100%, based on the maximum irradiation amount at the center. Further, in the case where it is necessary to reduce oxygen density by purge with nitrogen gas or the like in order to accelerate surface curing, the oxygen concentration is preferably from 0.01 to 5%, and the distribution thereof in the width direction is preferably 2% or less. In case of the ultraviolet ray irradiation, an ultraviolet ray emitted from a light source, for example, a super high pressure mercury lamp, a high pressure mercury lamp, a low pressure mercury lamp, a carbon arc lamp, a xenon arc or a metal halide lamp can be utilized. Also, in order to accelerate the curing reaction, it is possible to increase the temperature at the curing. In such a case, the temperature is preferably from 25 to 100° C., more preferably from 30 to 80° C., and most preferably from 40 to 70° C.

The hardcoat layer according to the invention can be coated, dried and cured as described above. Further, other functional layers can be provided, if desired. In the case of providing other functional layers in addition to the hardcoat layer, plural layers may be coated simultaneously or successively. The production of other functional layers can be conducted according to the method for producing the hardcoat layer.

### [Polarizing Plate]

The polarizing plate according to the invention is preferably a polarizing plate having a polarizing film and two protective films for protecting both surfaces of the polarizing film, wherein at least one of the protective films is the optical film according to the invention.

The polarizing plate according to the invention is more preferably a polarizing plate having at least one protective layer and a polarizing film, wherein at least one of the protective films is the optical film according to the invention and an optically anisotropic layer side of the optical film and the polarizing film are stuck. The optically anisotropic layer and the polarizing film are preferably stuck directly or through an adhesive agent layer or a sticky agent layer, and it is preferred to conduct the sticking without other member, for example, a transparent support. To conduct the sticking without other member is preferred because it can contribute to the reduction in thickness of the polarizing plate and the interference unevenness hardly occurs.

The polarizing film includes an iodine-based polarizing film, a dye-based polarizing film using a dichromatic dye and a polyene-based polarizing film. The iodine-based polarizing film and the dye-based polarizing film can be produced ordinarily using a polyvinyl alcohol film.

A configuration of the polarizing plate wherein the anisotropic layer side of the optical film is adhered to one side of the polarizing film through an adhesive agent or other base material and a protective film is also provided on the other side of the polarizing film is preferred. A configuration of the polarizing plate wherein the anisotropic layer side of the optical film is adhered to one side of the polarizing film through an adhesive layer is more preferred. In order to improve an adhesion property between the optically anisotropic layer and the polarizing film, the surface of the optically anisotropic layer is preferably subjected to a surface treatment (for example, glow discharge treatment, corona discharge treatment, plasma treatment, ultraviolet ray (UV) treatment, flame treatment, saponification treatment or solvent washing). Also, an adhesive layer (undercoat layer) may be provided on the optically anisotropic layer.

Also, a sticky agent layer may be provided on the side of the other protective film constituting the polarizing plate opposite to the polarizing film.

Use of the optical film according to the invention as a protective film for polarizing plate enables preparation of a polarizing plate having excellent physical strength, antifouling property and durability in addition to optical performance expected for a λ/4 film or the like.

The optical film according to the invention is preferably used as a surface film for liquid crystal display device.

Also, the polarizing plate according to the invention can have an optical compensation function. In such a case, it is preferred that the optical film according to the invention is provided on one side of the polarizing film as a protective film and an optical compensation film is provided on the other surface of the polarizing film as a protective film.

### [Image Display Device]

The optical film and the polarizing plate according to the invention is preferably used in an image display device, for example, a liquid crystal display device (LCD), a plasma display panel (PDP), an electroluminescence display (ELD) or a cathode ray tube display device (CRT). In particular, they are preferably used in the liquid crystal display device and are suitably for a stereoscopic image display device (3D display device). Above all, use in a transmission type liquid crystal display device of field-sequential two eyes stereoscopic vision is particularly preferred.

The liquid crystal display device ordinarily has a liquid crystal cell and two polarizing plates disposed on both sides of the liquid crystal cell, and the liquid crystal cell bears a liquid crystal between two electrode base materials.

A preferred embodiment of the liquid crystal display device according to the invention is a liquid crystal display device comprising the optical film according to the invention, a polarizing film, and a liquid crystal cell in this order from the viewing side, wherein the optical film is disposed so that the hardcoat layer thereof faces the viewing side and the optically anisotropic layer thereof faces the polarizing film.

The liquid crystal cell is preferably in a TN mode, a VA mode, an OCB mode, an IPS mode or an ECB mode.

### EXAMPLES

The characteristics of the invention will be more specifically described with reference to the examples and comparative examples below. The materials, amounts of use, proportions, contents of treatments, treating procedures and the like can be appropriately altered as long as the gist of the invention is not exceeded. Therefore, the scope of the invention should not be construed as being limited to the specific examples described below. Unless otherwise indicated specifically, all parts and percentages in the examples are on a weight basis.

### <Preparation of Transparent Support (Cellulose Acetate Film T1)>

The composition shown below was placed in a mixing tank and stirred with heating to solve the respective components, thereby preparing a cellulose acetate solution (Dope A) having solid content concentration of 22% by weight.

### [Composition of Cellulose Acetate Solution (Dope A)]

| | | |
|---|---|---|
| Cellulose acetate having acetyl group substitution | 100 | parts by |
| degree of 2.86 | | weight |
| Triphenyl phosphate (plasticizer) | 7.8 | parts by |
| | | weight |
| Biphenyl diphenyl phosphate (plasticizer) | 3.9 | parts by |
| | | weight |
| Ultraviolet absorbing agent (TINUVIN 328 produced | 0.9 | parts by |
| by Nihon Ciba-Geigy K.K.) | | weight |
| Ultraviolet absorbing agent (TINUVIN 326 produced | 0.2 | parts by |
| by Nihon Ciba-Geigy K.K.) | | weight |
| Methylene chloride (first solvent) | 336 | parts by |
| | | weight |
| Methanol (second solvent) | 29 | parts by |
| | | weight |
| 1-Butanol (third solvent) | 11 | parts by |
| | | weight |

Silica particle having an average particle size of 16 nm (AEROSIL R972 produced by Nippon Aerosil Co., Ltd.) was added to Dope A described above in an amount of 0.02 parts by weight per 100 parts by weight of cellulose acetate to prepare Dope B containing a matting agent. The solid content concentration of Dope B was adjusted to 19% by weight using the same solvent composition as Dope A.

Casting was conducted using a band stretching machine so that Dope A formed the main stream and Dope B containing a matting agent formed both the undermost layer and the uppermost layer. After reaching the surface temperature of the film on the band 40° C., the film was dried for 1 minute with hot air of 70° C. and removed from the band. The film was then dried for 10 minutes with drying air of 140° C. to prepare Cellulose acetate film T1 containing 0.3% by weight of the residual solvent. The casting amount was adjusted so that the thicknesses of the undermost layer and the uppermost layer both containing the matting agent became 3 μm respectively and the thickness of the main stream became 74 μm.

Cellulose acetate film T1 of a long-shape thus-obtained had a width of 2300 mm and a thickness of 80 μm. The in-plane retardation (Re) of the film at a wavelength of 550 nm was 3 nm and the retardation in the direction of thickness (Rth) thereof was 45 nm. The transmittance of the film at 380 nm was 3.8% and the average transmittance thereof at 450 to 650 nm was 92%.

The measurement of the retardation was conducted according to the method described hereinbefore.

The transmittance was measured by a spectrophotometer.

### <Preparation of Transparent Support (Cellulose Acetate Film T2)>

The composition shown below was placed in a mixing tank and stirred with heating to solve the respective components, thereby preparing a cellulose acetate solution (Dope C) having solid content concentration of 22% by weight.

[Composition of Cellulose Acetate Solution (Dope C)]

| | | |
|---|---|---|
| Cellulose acetate having acetyl group substitution | 100 | parts by |
| degree of 2.86 | | weight |
| Triphenyl phosphate (plasticizer) | 7.8 | parts by |
| | | weight |
| Biphenyl diphenyl phosphate (plasticizer) | 3.9 | parts by |
| | | weight |
| Ultraviolet absorbing agent (TINUVIN 328 produced | 0.45 | parts by |
| by Nihon Ciba-Geigy K.K.) | | weight |
| Ultraviolet absorbing agent (TINUVIN 326 produced | 0.10 | parts by |
| by Nihon Ciba-Geigy K.K.) | | weight |
| Methylene chloride (first solvent) | 336 | parts by |
| | | weight |
| Methanol (second solvent) | 29 | parts by |
| | | weight |
| 1-Butanol (third solvent) | 11 | parts by |
| | | weight |

Silica particle having an average particle size of 16 nm (AEROSIL R972 produced by Nippon Aerosil Co., Ltd.) was added to Dope C described above in an amount of 0.02 parts by weight per 100 parts by weight of cellulose acetate to prepare Dope D containing a matting agent. The solid content concentration of Dope D was adjusted to 19% by weight using the same solvent composition as Dope C.

Casting was conducted using a band stretching machine so that Dope C formed the main stream and Dope D containing a matting agent formed both the undermost layer and the uppermost layer. After reaching the surface temperature of the film on the band 40° C., the film was dried for 1 minute with hot air of 70° C. and removed from the band. The film was then dried for 10 minutes with drying air of 140° C. to prepare Cellulose acetate film T2 containing 0.3% by weight of the residual solvent. The casting amount was adjusted so that the thicknesses of the undermost layer and the uppermost layer both containing the matting agent became 3 μm respectively and the thickness of the main stream became 74 μm.

Cellulose acetate film T2 of a long-shape thus-obtained had a width of 2300 mm and a thickness of 80 μm. The in-plane retardation (Re) of the film at a wavelength of 550 nm was 3 nm and the retardation in the direction of thickness (Rth) thereof was 45 nm. The transmittance of the film at 380 nm was 19.5% and the average transmittance thereof at 450 to 650 nm was 92%.

### <Preparation of Transparent Support (Cellulose Acetate Film T3)>

The composition shown below was placed in a mixing tank and stirred with heating to solve the respective components, thereby preparing a cellulose acetate solution (Dope E) having solid content concentration of 22% by weight.

[Composition of Cellulose Acetate Solution (Dope E)]

| | | |
|---|---|---|
| Cellulose acetate having acetyl group substitution | 100 | parts by |
| degree of 2.86 | | weight |
| Triphenyl phosphate (plasticizer) | 7.8 | parts by |
| | | weight |
| Biphenyl diphenyl phosphate (plasticizer) | 3.9 | parts by |
| | | weight |
| Ultraviolet absorbing agent (TINUVIN 328 produced | 0.20 | parts by |
| by Nihon Ciba-Geigy K.K.) | | weight |
| Ultraviolet absorbing agent (TINUVIN 326 produced | 0.05 | parts by |
| by Nihon Ciba-Geigy K.K.) | | weight |
| Methylene chloride (first solvent) | 336 | parts by |
| | | weight |
| Methanol (second solvent) | 29 | parts by |
| | | weight |
| 1-Butanol (third solvent) | 11 | parts by |
| | | weight |

Silica particle having an average particle size of 16 nm (AEROSIL R972 produced by Nippon Aerosil Co., Ltd.) was added to Dope E described above in an amount of 0.02 parts by weight per 100 parts by weight of cellulose acetate to prepare Dope F containing a matting agent. The solid content concentration of Dope F was adjusted to 19% by weight using the same solvent composition as Dope E.

Casting was conducted using a band stretching machine so that Dope E formed the main stream and Dope F containing a matting agent formed both the undermost layer and the uppermost layer. After reaching the surface temperature of the film on the band 40° C., the film was dried for 1 minute with hot air of 70° C. and removed from the band. The film was then dried for 10 minutes with drying air of 140° C. to prepare Cellulose acetate film T3 containing 0.3% by weight of the residual solvent. The casting amount was adjusted so that the thicknesses of the undermost layer and the uppermost layer both containing the matting agent became 3 μm respectively and the thickness of the main stream became 74 μm.

Cellulose acetate film T3 of a long-shape thus-obtained had a width of 2300 mm and a thickness of 80 μm. The in-plane retardation (Re) of the film at a wavelength of 550 nm was 3 nm and the retardation in the direction of thickness (Rth) thereof was 45 nm. The transmittance of the film at 380 nm was 49.0% and the average transmittance thereof at 450 to 650 nm was 92%.

### <Preparation of Transparent Support (Cellulose Acetate Film T4)>

The composition shown below was placed in a mixing tank and stirred with heating to solve the respective components, thereby preparing a cellulose acetate solution (Dope G) having solid content concentration of 22% by weight.

[Composition of Cellulose Acetate Solution (Dope G)]

| | | |
|---|---|---|
| Cellulose acetate having acetyl group substitution | 100 | parts by |
| degree of 2.86 | | weight |
| Triphenyl phosphate (plasticizer) | 7.8 | parts by |
| | | weight |
| Biphenyl diphenyl phosphate (plasticizer) | 3.9 | parts by |
| | | weight |
| Ultraviolet absorbing agent (TINUVIN 328 produced | 0.18 | parts by |
| by Nihon Ciba-Geigy K.K.) | | weight |
| Ultraviolet absorbing agent (TINUVIN 326 produced | 0.04 | parts by |
| by Nihon Ciba-Geigy K.K.) | | weight |
| Methylene chloride (first solvent) | 336 | parts by |
| | | weight |
| Methanol (second solvent) | 29 | parts by |
| | | weight |
| 1-Butanol (third solvent) | 11 | parts by |
| | | weight |

Silica particle having an average particle size of 16 nm (AEROSIL R972 produced by Nippon Aerosil Co., Ltd.) was added to Dope E described above in an amount of 0.02 parts by weight per 100 parts by weight of cellulose acetate to prepare Dope H containing a matting agent. The solid content concentration of Dope H was adjusted to 19% by weight using the same solvent composition as Dope G.

Casting was conducted using a band stretching machine so that Dope G formed the main stream and Dope H containing a matting agent formed both the undermost layer and the uppermost layer. After reaching the surface temperature of the film on the band 40° C., the film was dried for 1 minute with hot air of 70° C. and removed from the band. The film was then dried for 10 minutes with drying air of 140° C. to prepare Cellulose acetate film T4 containing 0.3% by weight of the residual solvent. The casting amount was adjusted so that the thicknesses of the undermost layer and the uppermost layer both containing the matting agent became 3 μm respectively and the thickness of the main stream became 74 μm.

Cellulose acetate film T4 of a long-shape thus-obtained had a width of 2300 mm and a thickness of 80 μm. The in-plane retardation (Re) of the film at a wavelength of 550 nm was 3 nm and the retardation in the direction of thickness (Rth) thereof was 45 nm. The transmittance of the film at 380 nm was 52.0% and the average transmittance thereof at 450 to 650 nm was 92%.

### <Preparation of Transparent Support (Cellulose Acetate Film T5)>

The composition shown below was placed in a mixing tank and stirred with heating to solve the respective components, thereby preparing a cellulose acetate solution (Dope I) having solid content concentration of 22% by weight.

[Composition of Cellulose Acetate Solution (Dope I)]

| | | |
|---|---|---|
| Cellulose acetate having acetyl group substitution | 100 | parts by |
| degree of 2.86 | | weight |
| Triphenyl phosphate (plasticizer) | 7.8 | parts by |
| | | weight |
| Biphenyl diphenyl phosphate (plasticizer) | 3.9 | parts by |
| | | weight |
| Methylene chloride (first solvent) | 336 | parts by |
| | | weight |
| Methanol (second solvent) | 29 | parts by |
| | | weight |
| 1-Butanol (third solvent) | 11 | parts by |
| | | weight |

Silica particle having an average particle size of 16 nm (AEROSIL R972 produced by Nippon Aerosil Co., Ltd.) was added to Dope I described above in an amount of 0.02 parts by weight per 100 parts by weight of cellulose acetate to prepare Dope J containing a matting agent. The solid content concentration of Dope J was adjusted to 19% by weight using the same solvent composition as Dope I.

Casting was conducted using a band stretching machine so that Dope I formed the main stream and Dope J containing a matting agent formed both the undermost layer and the uppermost layer. After reaching the surface temperature of the film on the band 40° C., the film was dried for 1 minute with hot air of 70° C. and removed from the band. The film was then dried for 10 minutes with drying air of 140° C. to prepare Cellulose acetate film T5 containing 0.3% by weight of the residual solvent. The casting amount was adjusted so that the thicknesses of the undermost layer and the uppermost layer both containing the matting agent became 3 μm respectively and the thickness of the main stream became 74 μm.

Cellulose acetate film T5 of a long-shape thus-obtained had a width of 2300 mm and a thickness of 80 μm. The in-plane retardation (Re) of the film at a wavelength of 550 nm was 3 nm and the retardation in the direction of thickness (Rth) thereof was 45 nm. The transmittance of the film at 380 nm was 90% and the average transmittance thereof at 450 to 650 nm was 92%.

### <Preparation of Transparent Support (Cellulose Acetate Film T6)>

Casting was conducted using a band stretching machine so that Dope I formed the main stream and Dope J containing a matting agent formed both the undermost layer and the uppermost layer. After reaching the surface temperature of the film on the band 40° C., the film was dried for 1 minute with hot air of 70° C. and removed from the band. The film was then dried for 10 minutes with drying air of 140° C. to prepare Cellulose acetate film T6 containing 0.3% by weight of the residual solvent. The casting amount was adjusted so that the thicknesses of the undermost layer and the uppermost layer both containing the matting agent became 3 μm respectively and the thickness of the main stream became 34 μm.

Cellulose acetate film T6 of a long-shape thus-obtained had a width of 2300 mm and a thickness of 40 μm. The in-plane retardation (Re) of the film at a wavelength of 550 nm was 3 nm and the retardation in the direction of thickness (Rth) thereof was 20 nm. The transmittance of the film at 380 nm was 90% and the average transmittance thereof at 450 to 650 nm was 92%.

### <Preparation of Transparent Support (Cellulose Acetate Film T7)>

### (Preparation of Cellulose Acetate Solution K)

The composition shown below was placed in a mixing tank and stirred to solve the respective components, thereby preparing Cellulose acetate solution K.

### [Composition of Cellulose Acetate Solution K]

| | | |
|---|---|---|
| Cellulose acetate having acetyl group substitution | 100 | parts by |
| degree of 2.94 | | weight |
| Methylene chloride (first solvent) | 402 | parts by |
| | | weight |
| Methanol (second solvent) | 60 | parts by |
| | | weight |

### (Preparation of Matting Agent Solution)

A mixture of 20 parts by weight of silica particle having an average particle size of 16 nm (AEROSIL R972 produced by Nippon Aerosil Co., Ltd.) and 80 parts by weight of methanol was thoroughly stirred for 30 minutes to prepare a dispersion of silica particle. The dispersion was placed in a disperser together with the composition shown below and stirred for 30 minutes to solve the respective components, thereby preparing a matting agent solution.

### [Composition of Matting Agent Solution]

| | | |
|---|---|---|
| Dispersion of silica particle having average | 10.0 | parts by |
| particle size of 16 nm | | weight |
| Methylene chloride (first solvent) | 76.3 | parts by |
| | | weight |
| Methanol (second solvent) | 3.4 | parts by |
| | | weight |
| Cellulose acetate solution K | 10.3 | parts by |
| | | weight |

### (Preparation of Additive Solution)

The composition shown below was placed in a mixing tank and stirred with heating to solve the respective components, thereby preparing an additive solution.

### [Composition of Additive Solution]

| | |
|---|---|
| Optical anisotropy decreasing agent shown below | 49.3 parts by weight |
| Wavelength dispersion adjusting agent shown below | 4.9 parts by weight |
| Methylene chloride (first solvent) | 58.4 parts by weight |
| Methanol (second solvent) | 8.7 parts by weight |
| Cellulose acetate solution K | 12.8 parts by weight |

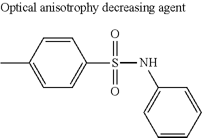

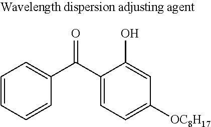

### (Preparation of Cellulose Acetate Film)

After conducting filtration of each of the solutions, 94.6 parts by weight of Cellulose acetate solution K, 1.3 parts by weight of the matting agent solution and 4.1 parts by weight of the additive solution were mixed and the mixture was cast using a band casting machine. The weight ratios of the optical anisotropy decreasing agent and wavelength dispersion adjusting agent in the composition were 12% by weight and 1.2% by weight based on the cellulose acetate, respectively. After reaching the amount of the residual solvent 30% by weight, the film was removed from the band, dried at 140° C. for 40 minutes to prepare Cellulose acetate film T7 of a long-shape having a width of 2,300 mm and a thickness of 80 μm. The in-plane retardation (Re) of the film was 1 nm (slow axis was perpendicular to the longitudinal direction of the film) and the retardation in the direction of thickness (Rth) thereof was −1 nm. The transmittance of the film at 380 nm was 90% and the average transmittance thereof at 450 to 650 was 92%.

### <Preparation of Optical Base Material F1>

### <<Formation of Optically Anisotropic Layer Containing Liquid Crystalline Compound>>

(Saponification Treatment with Alkali)

Cellulose acetate film T1 was passed between induction heating rolls having a temperature of 60° C. to raise the temperature of the film surface to 40° C., and then an alkali solution having the composition shown below was coated on the band surface of the film in a coating amount of 14 ml/m² using a bar coater. The film was then conveyed for 10 seconds under a steam type infrared heater (produced by Noritake Co., Ltd.) heated at 110° C. Then, pure water was coated in an amount of 3 ml/m² using the bar coater. Subsequently, after repeating 3 times the procedures of washing with water by a fountain coater and removing water by an air knife, the film was conveyed through a drying zone of 70° C. for 10 seconds to dry, thereby preparing a cellulose acetate film subjected to the saponification treatment with alkali.

### [Composition of Alkali Solution]

| | | |
|---|---|---|
| Potassium hydroxide | 4.7 | parts by |
| | | weight |
| Water | 15.8 | parts by |
| | | weight |
| Isopropanol | 63.7 | parts by |
| | | weight |
| Surfactant SF-1: C₁₄H₂₉O(CH₂CH₂O)₂₀H | 1.0 | parts by |
| | | weight |
| Propylene glycol | 14.8 | parts by |
| | | weight |

### (Formation of Oriented Film)

A coating solution for oriented film having the composition shown below was continuously coated on the cellulose acetate film of a long-shape subjected to the saponification treatment as described above using a wire bar. The coated film was dried for 60 seconds with hot air of 60° C. and then for 120 seconds with hot air of 100° C. The thickness of the oriented film was 0.7 μm.

### [Composition of Coating Solution for Oriented Film]

| | | |
|---|---|---|
| Modified polyvinyl alcohol shown below | 10 | parts by weight |
| Water | 371 | parts by weight |
| Methanol | 119 | parts by weight |
| Glutaraldehyde | 0.5 | parts by weight |
| Photopolymerization initiator (IRGACURE 2959 | 0.3 | parts by weight |
| produced by Ciba Specialty Chemicals Inc.) | | |

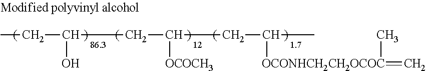

[Formation of Optically Anisotropic Layer Containing Discotic Liquid Crystalline Compound]

The oriented film prepared above was continuously subjected to a rubbing treatment. In the treatment, the longitudinal direction of the film of a long-shape and the conveying direction were parallel and the rotation axis of the rubbing roller was tilted at 45° in the counterclockwise direction with respect to the longitudinal direction of the film.

A coating solution containing a discotic crystalline compound having the composition shown below was continuously coated on the oriented film prepared above using a wire bar of #3.6. The conveying velocity (V) of the film was adjusted to 36 m/min. The film was heated for 90 seconds with hot air of 120° C. for drying the solvent of the coating solution and alignment ripening of the discotic liquid crystalline compound. Successively, UV irradiation was conducted at 80° C. to fix alignment of the liquid crystalline compound to form an optically anisotropic layer having a thickness of 1.6 μm, thereby obtaining Optical base material F1.

Optical base material F1 thus-prepared had the Re at 550 nm of 125 nm. The slow axis was in the direction of 45° clockwise with respect to the longitudinal direction of the film. The average tilt angle of the disc plane of the discotic crystalline molecule with respect to the film plane was 90° and it was confirmed that the discotic liquid crystal was vertically aligned with respect to the film plane. The arithmetic average roughness Ra (JIS B 0601:1998) of the surface on the side of the optically anisotropic layer was in a range from 0.01 to 0.04 μm and thus the surface had high smoothness.

### [Composition of Coating Solution for Optically Anisotropic Layer]

| | | |
|---|---|---|
| Discotic liquid crystalline compound shown below | 91 | parts by weight |
| Acrylate monomer shown below | 5 | parts by weight |
| Photopolymerization initiator (IRGACURE 907 produced by Ciba Specialty Chemicals Inc.) | 3 | parts by weight |
| Sensitizer (KAYACURE DETX produced by Nippon Kayaku Co., Ltd.) | 1 | parts by weight |
| Pyridinium salt shown below | 0.5 | parts by weight |
| Fluorine-based polymer (FP1) shown below | 0.2 | parts by weight |
| Fluorine-based polymer (FP3) shown below | 0.1 | parts by weight |
| Methyl ethyl ketone | 189 | parts by weight |

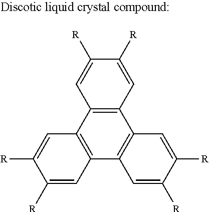

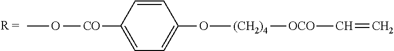

Acylate monomer:
Ethyleneoxide-modified trimethylolpropane triacrylate (V#360 produced by Osaka Organic Chemical Industry Ltd.)

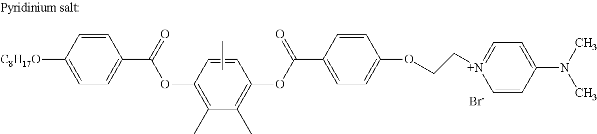

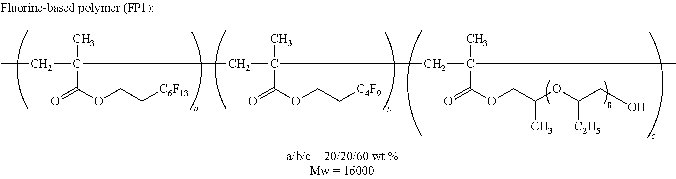

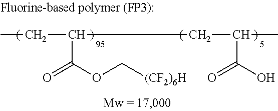

### <Preparation of Optical Base Materials F2 to F5>

Optical base materials F2 to F5 were prepared in the same manner as in the preparation method of Optical base material F1 except for changing Cellulose acetate film T1 to Cellulose acetate films T2 to T5, respectively. Each of Optical base materials F2 to F5 prepared had Re at 550 nm of 125 nm. The arithmetic average roughness Ra (JIS B 0601:1998) of the surface on the side of the optically anisotropic layer was in a range from 0.01 to 0.04 μm and thus the surface had high smoothness.

### <Preparation of Optical Base Material F6>

Optical base material F6 was prepared in the same manner as in the preparation method of Optical base material F1 except for changing Cellulose acetate film T1 to Cellulose acetate film T6. Optical base material F6 prepared had Re at 550 nm of 125 nm. The arithmetic average roughness Ra (JIS B 0601:1998) of the surface on the side of the optically anisotropic layer was in a range from 0.01 to 0.04 μm and thus the surface had high smoothness.

### <Preparation of Optical Base Material F7>

Optical base material F7 was prepared in the same manner as in the preparation method of Optical base material F1 except for changing Cellulose acetate film T1 to Cellulose acetate film T7. Optical base material F7 prepared had the Re at 550 nm of 125 nm. The arithmetic average roughness Ra (JIS B 0601:1998) of the surface on the side of the optically anisotropic layer was in a range from 0.01 to 0.04 μm and thus the surface had high smoothness.

### <Preparation of Optical Base Materials F8 to F15>

Optical base materials F8 to F15 were prepared in the same manner as in the preparation method of Optical base material F1 except for changing the thickness of the optically anisotropic layer so as to have Re value as shown in Table 1, respectively. The arithmetic average roughness Ra (JIS B 0601:1998) of the surface on the side of the optically anisotropic layer of each optical base material was in a range from 0.01 to 0.04 μm and thus the surface had high smoothness.

### <Preparation of Optical Base Material F16>

The oriented film of the base material (having the oriented film formed) before the formation of the optically anisotropic layer used in the preparation of Optical base material F1 was continuously subjected to a rubbing treatment. In the treatment, the longitudinal direction of the film of a long-shape and the conveying direction were parallel and the rotation axis of the rubbing roller was tilted at 45° in the counterclockwise direction with respect to the longitudinal direction of the film.

Using the coating solution (containing a rod-shaped liquid crystalline compound) for first optically anisotropic layer described in Paragraph No. [0117] of JP-A-2004-272202, the coating solution was coated while controlling the coating amount so as to have the Re at 550 nm of 125 nm and cured with an ultraviolet ray to form an optically anisotropic layer, thereby preparing Optical base material F16.

Optical base material F16 thus-prepared had the Re at 550 nm of 125 nm. The slow axis was in the direction of 45° clockwise with respect to the longitudinal direction of the support. The average tilt angle of the rod-shaped crystalline molecule with respect to the film plane was 0° and it was confirmed that the rod-shaped liquid crystal was horizontally aligned with respect to the film plane. The arithmetic average roughness Ra (JIS B 0601:1998) of the surface on the side of the optically anisotropic layer was in a range from 0.01 to 0.04 μm and thus the surface had high smoothness.

### <Preparation of Optical Base Material F17>

Optical base material F17 was prepared in the same manner as in the preparation method of Optical base material F16 except for changing Cellulose acetate film T1 to Cellulose acetate film T7.

The slow axis was in the direction of 45° clockwise with respect to the longitudinal direction of the support. The average tilt angle of the rod-shaped crystalline molecule with respect to the film plane was 0° and it was confirmed that the rod-shaped liquid crystal was horizontally aligned with respect to the film plane. The Re at 550 nm was 125 nm. The arithmetic average roughness Ra (JIS B 0601:1998) of the surface on the side of the optically anisotropic layer was in a range from 0.01 to 0.04 μm and thus the surface had high smoothness.

### <Preparation of Optical Base Material F18>

Optical base material F18 was prepared in the same manner as in the preparation method of Optical base material F16 except that the rotation axis of the rubbing roller was tilted at 45° in the clockwise direction with respect to the longitudinal direction of the film.

Optical base material F18 thus-prepared had the Re at 550 nm of 125 nm. The slow axis was in the direction of 45° counterclockwise with respect to the longitudinal direction of the support. The average tilt angle of the rod-shaped crystalline molecule with respect to the film plane was 0° and it was confirmed that the rod-shaped liquid crystal was horizontally aligned with respect to the film plane. The arithmetic average roughness Ra (MS B 0601:1998) of the surface on the side of the optically anisotropic layer was in a range from 0.01 to 0.04 μm and thus the surface had high smoothness.

### [Lamination of Hardcoat Layer]

Each coating solution for hardcoat layer shown below was prepared.

### (Preparation of Coating Solution HC-1 for Hardcoat Layer)

| | | |
|---|---|---|
| PET-30 (100%) | 53.7 | g |
| BISCOAT 360 (100%) | 32.2 | g |
| IRGACURE 127 (100%) | 3.2 | g |
| Crosslinked acryl particle of 8 μm (30% dispersion) | 33.6 | g |
| CAB polymer (20% solution) | 7.0 | g |
| SP-13 (5% solution) | 2.3 | g |
| MIBK | 36.8 | g |
| MEK | 26.1 | g |

The coating solution for hardcoat layer described above was filtered through a polypropylene filter having a pore size of 30 μm to prepare a coating solution. As for the coating solution described above, the refractive index of the matrix after curing was 1.525.

The materials used are shown below.

Crosslinked acryl particle of 8 μm: Refractive index: 1.495 (30% MIBK dispersion)

ET-30: Mixture of pentaerythritol triacrylate and pentaerythritol tetraacrylate (produced by Nippon Kayaku Co., ltd.)

BISCOAT 360: Ethyleneoxide-modified trimethylolpropane triacrylate (produced by Osaka Organic Chemical Industry Ltd.)

CAB polymer: Cellulose acetate butyrate (20% solution) (CAB-531-1 produced by Eastman Chemical Co., MIBK solution)

IRGACURE 127: Polymerization initiator (produced by Ciba Specialty Chemicals Inc.)

SP-13: Leveling agent; 5% MEK solution of fluorine-based polymer shown below

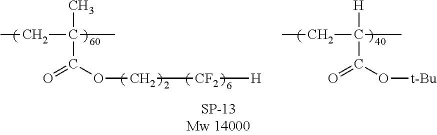

### (Preparation of Coating Solution Ln−1 for Low Refractive Index Layer)

Respective components shown below were mixed and dissolved in MEK/MMPG-AC mixture (90/10 in weight ratio) to prepare a coating solution for low refractive index layer having a solid content of 5% by weight.

### (Composition of Coating Solution Ln−1)

| | |
|---|---|
| Perfluoroolefin copolymer (P-1) shown below | 15 parts by weight |
| DPHA | 7 parts by weight |
| RMS-033 | 5 parts by weight |
| Fluorine-containing monomer (M-1) shown below | 20 parts by weight |
| Hollow silica particle (as solid content) | 50 parts by weight |
| IRGACURE 127 | 3 parts by weight |

The compounds used are shown below. 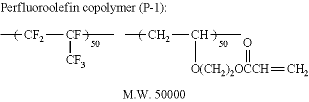
In the structural formula above, 50:50 indicates a molar ratio.

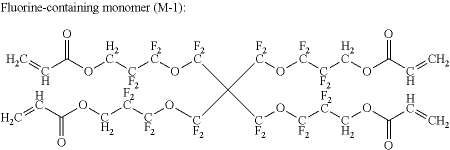

DPHA: Mixture of dipentaerythritol pentaacrylate and dipentaerythritol hexaacrylate (produced by Nippon Kayaku Co., ltd.)

RMS-033: Silicone-based polyfunctional acrylate (produced by Gelest, Inc., Mw=28,000)

IRGACURE 127: Photopolymerization initiator (produced by Ciba Specialty Chemicals Inc.)

Hollow silica particle: Dispersion of hollow silica particle (average particle size: 45 nm, refractive index: 1.25, surface-treated with an acryloyl group-containing silane coupling agent, MEK dispersion having concentration of 20%)

MEK: Methyl ethyl ketone

MMPG-Ac: Propylene glycol monomethyl ether acetate

The coating solution for low refractive index layer described above was filtered through a polypropylene filter having a pore size of 1 μm to prepare a coating solution. The refractive index after curing of the low refractive index layer obtained by coating and curing Coating solution Ln−1 for low refractive index layer described above was 1.36.

### [Preparation of Optical Film Sample]

### (Preparation of Optical Film Sample 107)

Optical base material F1 prepared above was unwound from the roll form and on the side of the support of Optical base material F1 opposite to the optically anisotropic layer was coated Coating solution HC-1 for hardcoat layer according to a die coating method using a slot die described in Example 1 of JP-A-2006-122889 under condition of a conveying speed of 30 m/min. After drying at 60° C. for 150 seconds, the coated layer was cured by irradiating with an ultraviolet ray with an irradiance of 400 mW/cm² and an irradiation amount of 100 mJ/cm² using an air-cooled metal halide lamp of 160 W/cm (produced by Eye Graphics Co., Ltd.) under the condition of an oxygen concentration of about 0.1% while purging with nitrogen, followed by winding up the film. The coating amount was adjusted so as to have the thickness of the hardcoat layer of 10 μm.

Then, the hardcoat film prepared above was unwound from the roll form and on the hardcoat layer was coated Coating solution HC-10 for hardcoat layer according to a die coating method using a slot die described in Example 1 of JP-A-2006-122889 under condition of a conveying speed of 30 m/min. After drying at 60° C. for 150 seconds, the coated layer was cured by irradiating with an ultraviolet ray with an irradiance of 400 mW/cm² and an irradiation amount of 100 mJ/cm² using an air-cooled metal halide lamp of 160 W/cm (produced by Eye Graphics Co., Ltd.) under the condition of an oxygen concentration of about 0.1% while purging with nitrogen, followed by winding up the film. The coating amount of Coating solution HC-10 for hardcoat layer was adjusted so as to have the thickness of the hardcoat layer of 4 μm (total thickness of the hardcoat layer: 14 μm). On the hardcoat layer was coated Coating solution Ln−1 for low refractive index layer to prepare Optical film sample 107. The drying condition of the low refractive index layer was at 60° C. for 60 seconds. The curing condition of the low refractive index layer with an ultraviolet ray was an irradiance of 600 mW/cm² and an irradiation amount of 300 mJ/cm² using an air-cooled metal halide lamp of 240 W/cm (produced by Eye Graphics Co., Ltd.) under an atmosphere of an oxygen concentration of about 0.1% while purging with nitrogen. The refractive index of the low refractive index layer was 1.36 and the thickness thereof was 95 nm.

### (Preparation of Optical Film Samples 101 to 106 and 108 to 112)

Optical film samples 101 to 106 and 108 to 112 were prepared in the same manner as in the preparation of Optical film sample 107 described above expect for adjusting the amount of particle in the coating solution for hardcoat layer so as to have the internal haze as shown in Table 2, respectively.

The adjustment of the amount of particle in the coating solution for hardcoat layer was conducted by the crosslinked acryl particle of 8 μm was replaced with PET-30 and BISCOAT 360 while maintaining the ratio of amounts of PET-30 and BISCOAT 360 added and the solid content concentration of Coating solution HC-1 for hardcoat layer constant.

### (Preparation of Optical Film Sample 113)

Optical film sample 113 was prepared in the same manner as in the preparation of Optical film sample 107 described above expect for changing Coating solution HC-1 for hardcoat layer to Coating solution HC-10 for hardcoat layer.

### (Preparation of Optical Film Samples 114 to 117)

Optical film samples 114 to 117 were prepared in the same manner as in the preparation of Optical film sample 107 described above expect that Coating solution HC-1 for hardcoat layer was changed to the coating solution for hardcoat layer used in Optical film sample 105 and that the thickness of the hardcoat layer formed from Coating solution HC-10 for hardcoat layer was adjusted so as to have the internal haze as shown in Table 2, respectively.

### (Preparation of Optical Film Samples 118 to 120)

Optical film samples 118 to 120 were prepared in the same manner as in the preparation of Optical film samples 102, 104 and 107 described above except that the irradiation amount after coating of Coating solution HC-10 for hardcoat layer was changed from 100 mJ/cm² to 300 mJ/cm² and that the laminate of the low refractive index layer was omitted.

### (Preparation of Optical Film Sample 121)

Optical film sample 121 was a sample in which neither the hardcoat layer nor the low refractive index layer was laminated in the preparation of Optical film sample 107 described above, specifically, Optical base material F1 per se.

### (Preparation of Optical Film Sample 122)

Optical film sample 122 was prepared in the same manner as in the preparation of Optical film samples 105 described above except for changing Optical base material F1 to Cellulose acetate film T1. In Optical film sample 122 the optically anisotropic layer was not laminated.

### (Preparation of Optical Film Samples 123 to 138)

Optical film samples 123 to 138 were prepared in the same manner as in the preparation of Optical film samples 105 described above except for changing Optical base material F1 to Optical base materials F2 to F17, respectively.

### (Preparation of Optical Film Sample 139)

Optical film sample 139 was prepared by sticking Optical film sample 138 described above and Optical film sample 122 with adhesive. Specifically, the optically anisotropic layer of Optical film sample 138 and the surface of Optical film sample 122 on which the hardcoat layer was not laminated were stuck.

Various characteristics of the optical film and transparent support were measured according to the methods described below.

### (Measurement of Characteristics of Optical Film and Transparent Support)

### (1) Surface Profile of Optical Film

The Ra (arithmetic average roughness in roughness curve) of the surface of the optical film on the hard coat layer side on which the optically anisotropic layer was not formed was measured according to JIS B 0601:1998.

### (2) Haze (Hz)

Total haze (H), internal haze (Hi) and surface haze (Hs) of the optical film were measured by the following manner.

1. The haze value (H) of the film was measured according to HS K 7136. The value obtained was referred to as the total haze.
2. After putting a few drops of silicone oil on the front surface of the film on the side of the hardcoat layer and on the back surface thereof, the film was sandwiched from the front and back sides by two sheets of glass plate each having a thickness of 1 mm (Micro Slide Glass No. S 9111 produced by Matsunami Glass Ind., Ltd.) to bring the film into optically complete contact with the two glass plates, thereby forming a state of eliminating the surface haze and then the haze was measured. From the value obtained, the haze value separately measured by interposing only the silicone oil between the glass plates was subtracted and the value obtained was calculated as the internal haze (Hi) of the film.
3. The internal haze (Hi) calculated in 2. above was subtracted from the total haze (H) measured in 1. above and the value obtained was calculated as the surface haze (Hs) of the film.

### (3) Average Reflectance (Integrating Sphere Reflectance)

The back side of optical film, that is, the surface on which the hardcoat layer was not coated, was roughened with sand paper, and then treated with black ink thereby forming a state of eliminating reflection on the back side. In the state, spectral reflectance on the front side was measured in a wavelength range from 380 to 780 nm using a spectrophotometer (produced by JASCO Corp.). As the average reflectance, the arithmetic average value of the integrating sphere reflectance in a range from 450 to 650 nm was used.

### (4) Pencil Hardness

Evaluation of pencil hardness described in JIS K 5400 was conducted to determine the scratch resistance. Specifically, the optical film was subjected to humidity control at temperature of 25° C. and humidity of 60% RH for 2 hours, on the surface of the hardcoat layer side of the optical film was conducted the scratching test five times using the pencils of 2H to 5H for testing defined in JIS S 6006 with a load of 4.9 N, then the optical film was allowed to stand under conditions of temperature of 25° C. and humidity of 60% RH for 24 hours and thereafter the evaluation was conducted according to the criteria shown below. The highest value of the hardness which fulfilled the level OK shown below was referred to as the evaluation value.

The case where the pencil hardness is less than 2H is at a problem level.

OK: Two or less scratches in the five-time evaluation.
NG: Three or more scratches in the five-time evaluation.

### (5) Transmittance at Wavelength of 380 nm

The transparent support was allowed to stand at 25° C. and 60% RH for 2 hours and then transmittance at a wavelength of 380 nm was measured using a spectrophotometer (U-3210 produced by Hitachi, Ltd.).

### [Preparation of Polarizing Plate and Image Display Device]

In order to evaluate the optical film as an image display device, the optical film was processed in the manner described below to form a polarizing plate and the polarizing plate was installed in an image display device.

The surface of the optically anisotropic layer of the optical film was washed with MEK. The surface of the film washed was subjected to an alkali saponification treatment. Specifically, the optical film was immersed in an aqueous 1.5 N sodium hydroxide solution at 55° C. for 2 minutes, washed in a water bath of room temperature, and neutralized with 0.1N sulfuric acid at 30° C. Then, the film was washed again in a water bath of room temperature and dried with hot air of 100° C.

A polyvinyl alcohol film having a thickness of 80 μm in a roll form was continuously stretched 5-fold in an aqueous iodine solution and dried to obtain a polarizing film having a thickness of 20 μm. The optical film subjected to the alkali saponification treatment described above and a retardation film for VA (produced by FUJIFILM Corp., Re/Rth at 550 nm=50/125) subjected to an alkali saponification treatment in a similar manner were prepared, and the polarizing film was sandwiched between the both films using an aqueous 3% solution of polyvinyl alcohol (PVA-117H produced by Kuraray CO. Ltd.,) as an adhesive so that the saponification-treated surface of each film faced the polarizing film, thereby preparing Polarizing plates 101 to 139 wherein the optical film and the retardation film for VA function as the protective films, respectively. The angle formed by the slow axis of the optical film and the absorption axis of the polarizer was adjusted to be 45°.

### (Mounting)

A polarizing plate on the viewing side of a TV (UN46C7000 (3D-TV) produced by Samsung) was removed and the retardation film for VA of the polarizing plate prepared above was stuck on the LC cell with an adhesive to prepare a stereoscopic image display device. The direction of the slow axis of the optically anisotropic layer of the optical film was identical in all display devices including the display device having Polarizing plate 139.

LC shutter spectacles: A polarizing plate of LC shutter spectacles (SSG-2100AB produced by Samsung) on the opposite side to the eye (panel side) was removed and the optically anisotropic layer side of Optical film sample 113 was stuck thereon with an adhesive to prepare LC shutter spectacles. The slow axis of the optical film stuck on the spectacles was adjusted in a direction perpendicular to the slow axis of the optical film included in the polarizing plate stuck on the TV.

### (Evaluation of Display Device)

A 3D image was viewed with wearing the LC shutter spectacles prepared above in a room with a fluorescent lamp under the condition that illuminance on the panel surface was about 200 lux.

Evaluation of the image was conducted by sensory evaluation of spectroscopic effect of the 3D image when viewed from the front and crosstalk of the 3D image when viewed from the front or from an oblique direction according to the criteria shown below.

### [Spectroscopic Effect]

A: The spectroscopic effect was recognized when viewed from the front.
B: The spectroscopic effect was not recognized when viewed from the front.

### [Crosstalk]

Crosstalk (double image) was observed when viewed from the front or when viewed from an oblique direction at 45° and evaluated according to the four-grade evaluation shown below.

A: The crosstalk was not observed at all.
B: Although the crosstalk was observed by careful view, it was enough to be ignored.
C: The crosstalk was faintly observed.
D: The crosstalk was clearly observed.

In the criteria shown above, grades A to C are in an acceptable level and grade D is at a problem level.

The evaluation results with respect to the items above are shown in Table 2.

### <Evaluation of Lightfastness>

The display device was irradiated with light using Super Xenon Weather Meter SX75 (produced by Suga Test Instruments Co., Ltd.) in an atmosphere of black panel temperature of 60° C. and relative humidity of 50% under the condition of intensity of ultraviolet ray from 300 to 400 nm of 150 W/m² for 100 hours and then film coloration and front retardation (Re) were measured. The irradiation light included ultraviolet light of 300 nm or more and visible light.

### <Denseness of Black>

With respect to the liquid crystal display device having the polarizing plate in which the film was stuck on the surface of the viewing side, denseness of black was evaluated by sensory evaluation.

The display devices prepared above were placed in parallel and evaluated at the same time by a relative comparison method. Specifically, the blackness at the time of power off viewed from the front in a bright room was compared with the respective films and evaluated according to the criteria shown below. The criteria indicate that the higher the blackness is, the stronger the denseness of the screen becomes.

A: The blackness was high and the denseness of the screen was very strong.
B: The blackness was high and the denseness of the screen was strong.
C: The black was grayish and the denseness of the screen was weak.
D: The black was remarkably grayish and the denseness of the screen was very weak.

In the criteria shown above, grades A to C are in an acceptable level and grade D is at a problem level.

### (Evaluation of Interference Unevenness)

The interference unevenness was evaluated the five-grade evaluation shown below.

Specifically, the display device described above was illuminated from the front with a three-wavelength fluorescent lamp (National Palook Fluorescent Lamp FL20SS•EX-D/18) at a distance of 50 cm and the interference unevenness was evaluated according to the criteria shown below.

A: The interference unevenness was not observed at all.
B: The interference unevenness was hardly observed.
BC: The interference unevenness was weakly observed partially.
C: The interference unevenness was weakly observed entirely.
D: The interference unevenness was strongly observed entirely.

In the criteria shown above, grades A to C are in an acceptable level and grade D is at a problem level.

TABLE 1

| | | | | | | UV Absorbing | | | | Optically | |
|---|---|---|---|---|---|---|---|---|---|---|---|
| | | | | Rth of | Optical | Agent in | Optically | | | Anisotropic | |
| | Sample | Transparent | Transmittance | Support | Base | Base | Anisotropic | | | Layer | |
| | No. | Support | at 380 nm | (nm) | Material | Material | Layer | HC Layer | Ln Layer | Re (nm) | Rth (nm) |
| Example | 101 | T1 | 3.8% | 45 | F1 | Present | Present | Present | Present | 125 | −63 |
| Example | 102 | T1 | 3.8% | 45 | F1 | Present | Present | Present | Present | 125 | −63 |
| Example | 103 | T1 | 3.8% | 45 | F1 | Present | Present | Present | Present | 125 | −63 |
| Example | 104 | T1 | 3.8% | 45 | F1 | Present | Present | Present | Present | 125 | −63 |
| Example | 105 | T1 | 3.8% | 45 | F1 | Present | Present | Present | Present | 125 | −63 |
| Example | 106 | T1 | 3.8% | 45 | F1 | Present | Present | Present | Present | 125 | −63 |
| Example | 107 | T1 | 3.8% | 45 | F1 | Present | Present | Present | Present | 125 | −63 |
| Example | 108 | T1 | 3.8% | 45 | F1 | Present | Present | Present | Present | 125 | −63 |
| Example | 109 | T1 | 3.8% | 45 | F1 | Present | Present | Present | Present | 125 | −63 |
| Example | 110 | T1 | 3.8% | 45 | F1 | Present | Present | Present | Present | 125 | −63 |
| Example | 111 | T1 | 3.8% | 45 | F1 | Present | Present | Present | Present | 125 | −63 |
| Example | 112 | T1 | 3.8% | 45 | F1 | Present | Present | Present | Present | 125 | −63 |
| Example | 113 | T1 | 3.8% | 45 | F1 | Present | Present | Present | Present | 125 | −63 |
| Example | 114 | T1 | 3.8% | 45 | F1 | Present | Present | Present | Present | 125 | −63 |
| Example | 115 | T1 | 3.8% | 45 | F1 | Present | Present | Present | Present | 125 | −63 |
| Example | 116 | T1 | 3.8% | 45 | F1 | Present | Present | Present | Present | 125 | −63 |
| Example | 117 | T1 | 3.8% | 45 | F1 | Present | Present | Present | Present | 125 | −63 |
| Example | 118 | T1 | 3.8% | 45 | F1 | Present | Present | Present | Absent | 125 | −63 |
| Example | 119 | T1 | 3.8% | 45 | F1 | Present | Present | Present | Absent | 125 | −63 |
| Example | 120 | T1 | 3.8% | 45 | F1 | Present | Present | Present | Absent | 125 | −63 |
| Comparative | 121 | T1 | 3.8% | 45 | F1 | Present | Present | Absent | Absent | 125 | −63 |
| Example | | | | | | | | | | | |
| Comparative | 122 | T1 | 3.8% | 45 | T1 | Present | Absent | Present | Present | — | — |
| Example | | | | | | | | | | | |
| Example | 123 | T2 | 19.5% | 45 | F2 | Present | Present | Present | Present | 125 | −63 |
| Example | 124 | T3 | 49.0% | 45 | F3 | Present | Present | Present | Present | 125 | −63 |
| Example | 125 | T4 | 52.0% | 45 | F4 | Present | Present | Present | Present | 125 | −63 |
| Example | 126 | T5 | 90.0% | 45 | F5 | Absent | Present | Present | Present | 125 | −63 |
| Example | 127 | T6 | 90.0% | 20 | F6 | Absent | Present | Present | Present | 125 | −63 |
| Example | 128 | T7 | 90.0% | −1 | F7 | Absent | Present | Present | Present | 125 | −63 |
| Comparative | 129 | T1 | 3.8% | 45 | F8 | Present | Present | Present | Present | 70 | −35 |
| Example | | | | | | | | | | | |
| Example | 130 | T1 | 3.8% | 45 | F9 | Present | Present | Present | Present | 80 | −40 |
| Example | 131 | T1 | 3.8% | 45 | F10 | Present | Present | Present | Present | 100 | −50 |
| Example | 132 | T1 | 3.8% | 45 | F11 | Present | Present | Present | Present | 110 | −55 |
| Example | 133 | T1 | 3.8% | 45 | F12 | Present | Present | Present | Present | 160 | −80 |
| Example | 134 | T1 | 3.8% | 45 | F13 | Present | Present | Present | Present | 170 | −85 |
| Example | 135 | T1 | 3.8% | 45 | F14 | Present | Present | Present | Present | 200 | −100 |
| Comparative | 136 | T1 | 3.8% | 45 | F15 | Present | Present | Present | Present | 210 | −105 |
| Example | | | | | | | | | | | |
| Comparative | 137 | T1 | 3.8% | 45 | F16 | Present | Present | Present | Present | 125 | 63 |
| Example | | | | | | | | | | | |
| Example | 138 | T7 | 90.0% | −1 | F17 | Present | Present | Present | Present | 125 | 63 |
| Comparative | 139 | T1 | 3.8% | 90 | F18 | Present | Present | Present | Present | 125 | 63 |
| Example | | | | | | | | | | | |

TABLE 2

| | | | | | | | | | | | | Inter- | | | | |
|---|---|---|---|---|---|---|---|---|---|---|---|---|---|---|---|---|
| | | | | Sur- | Inter- | | | | | | | ference | | | | Light- |
| | Sam- | Pencil | Total | face | nal | | | | | Reflec- | Dense- | Un- | Spectro- | Cross- | Cross- | fast- |
| | ple | Hard- | Hz | Hz | Hz | Ra | Re | Rth | | tance | ness | even- | scopic | talk | talk | ness |
| | No. | ness | (%) | (%) | (%) | (μm) | (nm) | (nm) | Nz | (%) | of black | ness | effect | (front) | (oblique) | Re (nm) |
| Example | 101 | 4H | 1.0 | 0.0 | 1.0 | 0.01 | 125 | −18 | 0.36 | 1.2 | A | BC | A | A | A | 125 |
| Example | 102 | 4H | 2.0 | 0.0 | 2.0 | 0.01 | 125 | −18 | 0.36 | 1.2 | A | BC | A | A | A | 125 |
| Example | 103 | 4H | 3.0 | 0.0 | 3.0 | 0.01 | 125 | −18 | 0.36 | 1.2 | A | B | A | A | A | 125 |
| Example | 104 | 4H | 4.0 | 0.0 | 4.0 | 0.01 | 125 | −18 | 0.36 | 1.2 | A | B | A | A | A | 125 |
| Example | 105 | 4H | 5.0 | 0.0 | 5.0 | 0.01 | 125 | −18 | 0.36 | 1.2 | A | A | A | A | A | 125 |
| Example | 106 | 4H | 6.0 | 0.0 | 6.0 | 0.01 | 125 | −18 | 0.36 | 1.2 | A | A | A | A | A | 125 |
| Example | 107 | 4H | 7.0 | 0.0 | 7.0 | 0.01 | 125 | −18 | 0.36 | 1.2 | B | A | A | A | A | 125 |
| Example | 108 | 4H | 10.0 | 0.0 | 10.0 | 0.01 | 125 | −18 | 0.36 | 1.2 | B | A | A | A | A | 125 |
| Example | 109 | 4H | 11.0 | 0.0 | 11.0 | 0.01 | 125 | −18 | 0.36 | 1.2 | C | A | A | A | A | 125 |
| Example | 110 | 4H | 15.0 | 0.0 | 15.0 | 0.01 | 125 | −18 | 0.36 | 1.2 | C | A | A | A | A | 125 |
| Example | 111 | 4H | 20.0 | 0.0 | 20.0 | 0.01 | 125 | −18 | 0.36 | 1.2 | C | A | A | A | A | 125 |
| Example | 112 | 4H | 0.8 | 0.0 | 0.8 | 0.01 | 125 | −18 | 0.36 | 1.2 | A | C | A | A | A | 125 |
| Example | 113 | 4H | 0.1 | 0.0 | 0.1 | 0.01 | 125 | −18 | 0.36 | 1.2 | A | C | A | A | A | 125 |
| Example | 114 | 4H | 5.2 | 0.2 | 5.0 | 0.05 | 125 | −18 | 0.36 | 1.2 | A | A | A | A | A | 125 |
| Example | 115 | 4H | 5.3 | 0.3 | 5.0 | 0.06 | 125 | −18 | 0.36 | 1.2 | B | A | A | A | A | 125 |
| Example | 116 | 4H | 5.4 | 0.4 | 5.0 | 0.07 | 125 | −18 | 0.36 | 1.2 | B | A | A | A | A | 125 |
| Example | 117 | 4H | 5.6 | 0.6 | 5.0 | 0.08 | 125 | −18 | 0.36 | 1.2 | C | A | A | A | A | 125 |
| Example | 118 | 4H | 2.0 | 0.0 | 2.0 | 0.01 | 125 | −18 | 0.36 | 4.3 | A | BC | A | A | A | 125 |
| Example | 119 | 4H | 4.0 | 0.0 | 4.0 | 0.01 | 125 | −18 | 0.36 | 4.3 | B | B | A | A | A | 125 |
| Example | 120 | 4H | 7.0 | 0.0 | 7.0 | 0.01 | 125 | −18 | 0.36 | 4.3 | C | A | A | A | A | 125 |
| Comparative | 121 | <2H | 0.1 | 0.0 | 0.1 | 0.01 | 125 | −18 | 0.36 | 4.0 | A | C | A | A | A | 125 |
| Example | | | | | | | | | | | | | | | | |
| Comparative | 122 | 4H | 0.1 | 0.0 | 0.1 | 0.01 | 3 | 45 | 15.5 | 1.1 | A | A | B | D | D | — |
| Example | | | | | | | | | | | | | | | | |
| Example | 123 | 4H | 5.0 | 0.0 | 5.0 | 0.01 | 125 | −18 | 0.36 | 1.2 | A | A | A | A | A | 120 |
| Example | 124 | 4H | 5.0 | 0.0 | 5.0 | 0.01 | 125 | −18 | 0.36 | 1.2 | A | A | A | A | A | 110 |
| Example | 125 | 4H | 5.0 | 0.0 | 5.0 | 0.01 | 125 | −18 | 0.36 | 1.2 | A | A | A | A | A | 105 |
| Example | 126 | 4H | 5.0 | 0.0 | 5.0 | 0.01 | 125 | −18 | 0.36 | 1.2 | A | A | A | A | A | 90 |
| Example | 127 | 4H | 5.0 | 0.0 | 5.0 | 0.01 | 125 | −43 | 0.16 | 1.2 | A | A | A | A | B | 90 |
| Example | 128 | 4H | 5.0 | 0.0 | 5.0 | 0.01 | 125 | −64 | 0.00 | 1.2 | A | A | A | A | C | 90 |
| Comparative | 129 | 4H | 5.0 | 0.0 | 5.0 | 0.01 | 70 | 10 | 0.64 | 1.2 | A | A | B | D | D | 70 |
| Example | | | | | | | | | | | | | | | | |
| Example | 130 | 4H | 5.0 | 0.0 | 5.0 | 0.01 | 80 | 5 | 0.56 | 1.2 | A | A | A | C | C | 80 |
| Example | 131 | 4H | 5.0 | 0.0 | 5.0 | 0.01 | 100 | −5 | 0.45 | 1.2 | A | A | A | B | B | 100 |
| Example | 132 | 4H | 5.0 | 0.0 | 5.0 | 0.01 | 110 | −10 | 0.41 | 1.2 | A | A | A | A | A | 110 |
| Example | 133 | 4H | 5.0 | 0.0 | 5.0 | 0.01 | 160 | −35 | 0.28 | 1.2 | A | A | A | A | A | 160 |
| Example | 134 | 4H | 5.0 | 0.0 | 5.0 | 0.01 | 170 | −40 | 0.26 | 1.2 | A | A | A | B | B | 170 |
| Example | 135 | 4H | 5.0 | 0.0 | 5.0 | 0.01 | 200 | −55 | 0.23 | 1.2 | A | A | A | C | C | 200 |
| Comparative | 136 | 4H | 5.0 | 0.0 | 5.0 | 0.01 | 210 | −60 | 0.21 | 1.2 | A | A | B | D | D | 210 |
| Example | | | | | | | | | | | | | | | | |
| Comparative | 137 | 4H | 5.0 | 0.0 | 5.0 | 0.01 | 200 | 108 | 1.36 | 1.2 | A | A | A | B | D | 125 |
| Example | | | | | | | | | | | | | | | | |
| Example | 138 | 4H | 5.0 | 0.0 | 5.0 | 0.01 | 200 | 62 | 1.00 | 1.2 | A | A | A | B | C | 125 |
| Comparative | 139 | 4H | 0.1 | 0.0 | 0.1 | 0.01 | 200 | 153 | 1.72 | 1.2 | A | D | A | B | D | 125 |
| Example | | | | | | | | | | | | | | | | |

The followings are apparent from the results shown in Tables 1 and 2.

1. The optical film comprising an optically anisotropic layer on one side of a support and a hardcoat layer on the other side of the support, wherein in-plane retardation of the optical film at a wavelength of 550 nm is from 80 to 200 nm and retardation in a direction of thickness of the optical film at a wavelength of 550 nm is from −70 to 70 nm is suitable for a stereoscopic image display device, has high surface hardness, exhibits good denseness of black and is prevented from the generation of interference unevenness.

2. The display device having a hardcoat film stuck on an optical film having an optically anisotropic layer with an adhesive has a large thickness and exhibits severe interference unevenness (for example, Sample No. 139 in comparison with Sample No. 138).

3. The optically anisotropic layer according to the invention can be formed from a discotic liquid crystalline compound and a rod-shaped liquid crystalline compound.

4. The display device having an optically anisotropic layer formed from a discotic liquid crystalline compound is prevented from the crosstalk when viewed from an oblique direction and excellent in the visibility in comparison with the display device having an optically anisotropic layer formed from a rod-shaped liquid crystalline compound (for example, Sample No. 105 in comparison with Sample Nos. 137 and 138).

5. By adjusting the Ra to a range from 0 to 0.08 μm and the internal haze to a range from 1 to 20% in the hardcoat layer, the interference unevenness becomes more unnoticeable while maintaining the good denseness of black.

6. By laminating a low refractive index layer on the hardcoat layer, the reflectance can be reduced, the interference unevenness becomes unnoticeable, and the denseness of black is more improved (for example, Sample No. 107 in comparison with Sample No. 120).

7. By using the transparent support of an ultraviolet ray absorbing property having the transmittance at a wavelength of 380 nm of 50% or less, the change in the front retardation after the light-fastness test can be remarkably inhibited (for example, Sample No. 105 in comparison with Sample Nos. 123 to 126).

What is claimed is:

1. An optical film comprising, in the following order: an optically anisotropic layer; a transparent support; and a hardcoat layer, wherein in-plane retardation of the optical film at a wavelength of 550 nm is from 80 to 200 nm and retardation in a direction of thickness of the optical film at a wavelength of 550 nm is from −70 to 70 nm.

2. The optical film as claimed in claim 1, which further comprises an oriented film between the transparent support and the optically anisotropic layer.

3. The optical film as claimed in claim 1, wherein retardation in a direction of thickness of the transparent support at a wavelength of 550 nm is from 20 to 100 μm.

4. The optical film as claimed in claim 1, wherein the optically anisotropic layer is formed form a composition containing a liquid crystalline compound.

5. The optical film as claimed in claim 4, wherein the liquid crystalline compound is a discotic liquid crystalline compound.

6. The optical film as claimed in claim 1, wherein a surface irregularity shape of a surface of the optical film on a side at which the hardcoat layer is provided is from 0 to 0.08 μm in terms of an arithmetic average roughness Ra according to HS B 0601.

7. The optical film claimed in claim 1, wherein the optical film has a surface haze of 1% or less.

8. The optical film as claimed in claim 1, wherein the optical film has an internal haze of from 1 to 10%.

9. The optical film as claimed in claim 1, wherein a transmittance of the transparent support at a wavelength of 380 nm is 10% or less.

10. The optical film as claimed in claim 1, wherein the hardcoat layer contains a binder and a light-transmitting particle, an average particle size of the light-transmitting particle is from 1 to 12 μm, and an absolute value of a refractive index difference between the binder and the light-transmitting particle is from 0.01 to less than 0.05.

11. The optical film as claimed in claim 1, wherein a low refractive index layer having a refractive index lower than that of the transparent support is provided on a side of the hardcoat layer opposite to a side provided with the transparent support.

12. The optical film as claimed in claim 1, which is in a long-length roll form and a slow axis of in-plane retardation is present at 5 to 85° in a clockwise or counterclockwise direction with reference to a longitudinal direction.

13. The optical film as claimed in claim 1, which is a surface film for a liquid crystal display device.

14. A polarizing plate comprising at least one protective film and a polarizing film, wherein at least one of the at least one protective film is the optical film as claimed in claim 1, and a surface of the optically anisotropic layer side of the optical film and the polarizing film are stuck.

15. An image display device comprising the optical film as claimed in claim 1.

16. A liquid crystal display device comprising the optical film as claimed in claim 1, a polarizing film and a liquid crystal cell in this order from a viewing side, wherein the optical film is provided so that the hardcoat layer is arranged on the viewing side and the optically anisotropic layer is arranged on the polarizing film side.
